(19) United States
(12) Patent Application Publication
(10) Pub. No.: US 2006/0266715 A1
(43) Pub. Date: Nov. 30, 2006

(54) Separation and accumulation of subcellular components, and proteins derived therefrom

(76) Inventor: Zvi Loewy, Fairlawn, NJ (US)

Correspondence Address: FROMMER LAWRENCE & HAUG, 745 FIFTH AVENUE- 10TH FL., NEW YORK, NY, 10151, US

(21) Appl. No.: 11/266,921

(22) Filed: Nov. 4, 2005

Related U.S. Application Data
(63) Continuation of application No. 11/029,138, filed on Jan. 4, 2005, now abandoned.
Application No. 11/029,138 is a continuation of application No. 10/805,470, filed on Mar. 19, 2004, now abandoned.
(60) Provisional application No. 60/455,767, filed on Mar. 19, 2003.

(51) Int. Cl. C02F 1/38

(52) U.S. Cl. 210/787; 436/177; 705/1; 435/4

(57) ABSTRACT

The present invention provides for proteome fractionation through the separation and accumulation of subcellar organelles from a biological sample such that the subcellular organelles are highly enriched, substantially pure, and whose structural integrity and functions are well-preserved. The methods of the invention provide a manner by which to reduce the complexity of the proteome and facilitate the detection and isolation of difficult-to-study proteins, such as low-abundance proteins. The methods of the present invention for pre-fractioning proteomes of biological samples by parallel separation and isolation of subcellular organelles from the biological samples using continuous-flow ultracentrifugation are also easily and effectively scalable through adjustment to ultracentrifugation parameters, such as, for example, rotor speed, rotor size, rotor geometry.

### RELATED APPLICATIONS/PATENTS & INCORPORATION BY REFERENCE

A claim of priority is made to U.S. Provisional Application No. 60/455,767, filed Mar. 19, 2003 and to U.S. application Ser. No. 10/741,313, filed Dec. 19, 2003. This application is a continuation of U.S. application Ser. No. 11/029,138 filed on Jan. 4, 2005 which is a continuation of Ser. No. 10/805,470 filed on Mar. 19, 2004. Reference is made to U.S. application Ser. No. 09/995,054, filed Nov. 27, 2001.

Each of the applications and patents cited in this text, as well as each document or reference cited in each of the applications and patents (including during the prosecution of each issued patent; “application cited documents”), and each of the PCT and foreign applications or patents corresponding to and/or claiming priority from any of these applications and patents, and each of the documents cited or referenced in each of the application cited documents, are hereby expressly incorporated herein by reference. More generally, documents or references cited in this text; and, each of these documents or references (“herein-cited references”), as well as each document or reference cited in each of the herein-cited references (including any manufacturer's specifications, instructions, etc.), are hereby expressly incorporated herein by reference.

### FIELD OF THE INVENTION

The present invention relates generally to the field of proteomics and to fields which can utilize subcellular proteomes. More in particular, the instant invention relates to methods for the fractionation of a proteome of a biological sample to achieve improved detection and analysis of proteins comprising said proteome, in particular, the detection and analysis of low-abundance proteins. In a further aspect, the instant invention relates to the parallel separation and isolation of different types of subcellular organelles from any biological sample by continuous-flow ultracentrifugation. Further, the method of the instant invention provides for purity, enrichment, accumulation, and integrity of isolated subcellular organelles and for proteins contained therein, thereby offering an enhanced strategy to study and analyze subcellular proteoms, especially low-abundance proteins.

### BACKGROUND

Proteomics attempts to understand biological phenomena—e.g., disease, cellular differentiation, growth cycles, and evolution—via a detailed knowledge and appreciation of the functions, subcellular or extracellular locations, interactions, activities, and quantities for each and every protein of a cell and/or tissue. Such an understanding will greatly advance, for example, the diagnosis, treatment, and prevention of disease. Proteomics finds applicability in, for example, drug discovery, preclinical and clinical research, clinical diagnostics, veterinary medicine, forensics, agrochemistry and biotherapeutics.

Compared to the field of genomics, however, proteomics is regarded as having a significantly higher level of complexity. This complexity results from the dynamic changes in protein content, localization, post-translational modifications, and protein-protein interactions, typically as a function of time. These changes vary among individuals, tissues, cells and organelles, and occur in response to, for example, growth, differentiation, senescence, environmental changes and disease.

At present, there is no single strategy that can sufficiently address all levels of the proteome organization. Furthermore, monitoring dynamic proteome changes such as, for example, protein localization, requires special techniques for proteome analysis at the organelle level.

Subcellular fractionation techniques traditionally have been among the key methods in cell biology and biochemistry for isolating and characterizing organelles (Bonifacino et al., (2000), Supplement 3-6, John Wiley &Sons, Inc., NY). These procedures exploit various separation techniques, such as, density gradient centrifugation, free-flow electrophoresis and ligand affinity chromatography. In most cases, preparations of subcellular organelles are optimized for a single, targeted organelle prepared from distinct sources. Apart from isolating the targeted organelle, the remainder of the preparation is generally regarded as debris and discarded.

One example of isolating a targeted organelle is described in Price et al. ((1973), Analytical Biochemistry 54:239-246), wherein the authors describe isolation and separation of intact chloroplasts from spinach brie by continuous-flow zonal centrifugation in a CF-6 rotor in gradients of colloidal silica. The authors report the recovery of chloroplasts which is supported by phase contrast microscopy and concentration of chloroplast specific proteins per unit of chlorophyll material. In another example, Cline and Dagg ((1978) Methodological Developments in Biochemistry, Longman, p. 61-70) report separation of chloroplasts from other plant cell components using continuous sample-flow with isopycnic banding zonal rotors such as J-I and RK-II.

Other reports of monitoring dynamic changes in the proteome at the subcellular level are described in the articles mentioned below.

Dreger et al., ((2003), Mass. Spec., 22:27-56) reports that monitoring dynamic proteome changes at the organelle level, such as, for example, protein translocation events, is an especially difficult task because most fractionation techniques are designed to enrich for a single type of organelle. The authors report that there is a need in the art to develop new cellular fractionation techniques for monitoring at least two types of organelles in parallel in order to provide one skilled in the art with the elucidation of organelle-specific protein translocations.

Dreger et al., ((2003) Eur. J. Biochem., 270:589-599) reports the need for improving techniques for monitoring protein translocation events as several proteins may be associated with certain subcellular structures only in certain physiological states. While the authors state that it is possible to separate major cellular fractions, such as, for examples, cytosolic and nucleoplasmic fractions, the authors report that these studies provide limited information on the dynamic proteome changes to one skilled in the art as they do not enrich for organelles and, as a result, do not elucidate organelle-specific protein translocation.

Additionally, Gemer et al., ((2000) J. Biol. Chem. 275:39018-39026) analyzes the effect of Fas-induced apoptosis on the cellular localization of the TCP-1A protein. This study does not provide one skilled in the art, however, with information as to which specific organelle in the cytosol has acquired the TCP-1A protein. Obtaining this information would be useful for designing specific therapeutics aimed at blocking or enhancing specific protein translocation events.

Similar studies were reviewed by Huber et al. ((2003) Circulation Research, 92:962-968). In this recent 2003 review, the authors note that the present state of the art allows for fractionation of cells by differential centrifugation into three major components such as cytosol, nuclei and membranes. Similar to the Gerner et al. article, these studies do not provide information on the dynamic changes in the organelle-specific protein localization.

At present, there still exists a need in the art to develop subcellular fractionation techniques wherein at least two types of organelles can be simultaneously enriched, accumulated and separated while maintaining high purity and intactness, thereby increasing the detection threshold for proteins, such as, for example, low-abundant proteins. A need also exists in the art to develop fractionation techniques whereby subtypes of subcellular organelles can be accumulated and separated in sufficient quantity and qualitatively resolved whereby the proteomic profiles of the subtypes of subcellular organelles can be determined.

### SUMMARY OF THE INVENTION

One aspect of the invention relates to separation and accumulation of organelles, such as subcellular organelles, from a sample, preferably a biological sample. The separation and accumulation of the organelles are performed by, for example, fractionation by a continuous-flow process. The continuous-flow process, in turn, utilizes centrifugal force, such as that generated by a centrifuge. In an embodiment, a continuous-flow ultracentrifuge is used to separate and accumulate organelles. It is understood, however, that other continuous-flow processes can be used and that the instant invention is not limited to the use of an ultracentrifuge. The contents of the organelles are fractionated. For example, the organelles can be lysed and the proteome released therefrom. The proteins and peptides from the proteome can be separated by, for example, chromatography, electrophoresis, continuous-flow centrifugation or other art-recognized techniques. The separated proteins and peptides can be characterized and quantitatively analyzed by a number of techniques such as, for example, mass spectrometry. Afterwards, the proteins can be identified, if possible, characterized and used for downstream applications.

More specifically, both the separated and accumulated subcellular organelles, and the separated and accumulated low-abundance proteins, can be used in downstream applications. Such applications include, for example, selling the subcellular organelles and/or low-abundance proteins, leasing the subcellular organelles and/or low-abundance proteins, licensing the subcellular organelles and/or low-abundance proteins, protecting an intellectual property interest in the subcellular organelles and/or low-abundance proteins and placing information about the subcellular organelles and/or low-abundance proteins into a database which can optionally be provided to third parties.

Against this background, and in accordance with one embodiment of the present invention, a method is provided for enriching and accumulating organelles from a sample comprising the organelles, having the steps of: a) releasing the organelles from the sample; b) introducing the organelles to a density gradient within a continuous-flow centrifuge; c) applying a centrifugal force sufficient for at least two types of organelles to migrate within the density gradient; and d) collecting the at least two types of subcellular organelles from the density gradient so as to utilize the at least two types of subcellular organelles.

In another embodiment of the invention, a method is provided for accumulating low abundance proteins from organelles, having the steps of: a) releasing the organelles from a sample comprising the organelles; b) introducing the organelles to a density gradient within a continuous-flow centrifuge; c) applying a centrifugal force such that organelles enrich and accumulate within the density gradient; d) collecting the organelles from the density gradient; e) lysing the organelles to form a proteome; and f) collecting the low-abundance proteins from the proteome.

In a further embodiment of the invention, a method is provided for separating at least two types of organelles from a biological sample comprising the at least two types of organelles, having the steps of: a) releasing the at least two types of subcellular organelles from the sample in a homogenate; b) continuously flowing the homogenate over a density gradient and applying a centrifugal force in an amount sufficient for each of the at least two types of organelles to enter and migrate in the density gradient to a position in the density gradient such that the density of the gradient and the buoyant density of each respective organelle are substantially equal; and c) isolating the at least two types of organelles from the density gradient.

In a still another embodiment of the invention, a method for enriching and accumulating at least two types of organelles from a biological sample, having the steps of: a) obtaining the biological sample from tissue or cell material; b) homogenizing the tissue material or lysing the cell material to form an organelle homogenate; c) feeding said organelle homogenate into a continuous-flow ultracentrifuge having a density gradient; d) applying a centrifugal force such that at least two types of organelles migrate and accumulate within the density gradient; and e) collecting the at least two types of organelles from the density gradient so as to utilize the at least two types of organelles.

In yet another embodiment of the invention, a method is provided for accumulating low abundance proteins from a subcellular organelle, having the steps of: a) releasing the subcellular organelles from a sample comprising the subcellular organelles; b) introducing the subcellular organelles to a density gradient within a continuous-flow centrifuge; c) applying a centrifugal force such that subcellular organelles migrate and accumulate within the density gradient; d) collecting the subcellular organelles from the density gradient; e) lysing the subcellular organelles to form a proteome suspension; f) collecting the low-abundance proteins from the proteome suspension; and g) utilizing the low-abundance protein in a process selected from the group consisting of selling the low-abundance proteins, leasing the low-abundance proteins, licensing the low-abundance proteins, protecting an intellectual property interest in the low-abundance proteins, placing information about said low-abundance proteins into a database and viewing information about the low abundance proteins in a database.

In a still another embodiment of the invention, a method is provided for purifying and accumulating subcellular organelles from a biological sample comprising said subcellular organelles, having the steps of: a) introducing said biological sample into a centrifuge, said centrifuge comprising a density gradient solution adapted to separate into discrete layers, each of said layers having a holding capacity; and b) centrifuging said biological sample in a continuous mode to produce said accumulated and purified subcellular organelles in said discrete layers within said density gradient solution, wherein each of the at least two types of subcellular organelles migrate within separate discrete layers within said density gradient solution, wherein said at least two types of subcellular organelles are accumulated at a concentration at or immediately below the holding capacity of said at least two discrete layers, and wherein said at least two accumulated subcellular organelles are substantially intact.

In a yet further embodiment of the invention, a method is provided for accumulating subcellular organelles, having the step of using a continuous-flow ultracentrifuge to obtain said subcellular organelles from a biological sample in sufficient yield and purity so as to isolate and detect a low-abundance protein therefrom.

In another embodiment of the invention, a method is provided for accumulating at least two different types of subcellular organelles, having the step of using a continuous-flow ultracentrifuge to obtain said at least two different types of subcellular organelles from a biological sample in sufficient yield and purity so as to isolate and detect a low abundance protein therefrom.

In a still further embodiment of the present invention, a method is provided for analyzing proteomic profiles of at least two types of subcellular organelles as a function of time, having the steps of: a) releasing the at least two types of subcellular organelles from a biological sample at a first time; b) introducing the at least two types of subcellular organelles to a density gradient within a continuous-flow ultracentrifuge; c) applying a centrifugal force such that the at least two types of subcellular organelles migrate within the density gradient; d) collecting the at least two types of subcellular organelles from the density gradient; e) isolating and purifying proteins from said at least two types of subcellular organelles to determine a proteomic profile of said at least two types of subcellular organelles at said first time; f) releasing the at least two types of subcellular organelles from a second biological sample at a second time; g) repeating steps b) through d); h) isolating and purifying proteins from said at least two types of subcellular organelles to determine a proteomic profile of said at least two types of subcellular organelles at a second time; and i) analyzing the proteomic profiles at said first and second times to detect changes in said proteomic profiles as a function of time.

In a still further embodiment of the invention, a method is provided for analyzing the translocation process of a translocation protein of a biological sample, said translocation process relating to the intracellular movement of the translocation protein as a function of time from a first organelle to a second organelle of said biological sample, said function of time having at least two time points, having the steps of: (a) determining the relative amounts of said translocation protein in said first and second organelle of a first biological sample, said first biological sample being isolated at a first time point, comprising the steps of: homogenizing the first biological sample under conditions sufficient to release said first and second organelles into a homogenate, said first and second organelles each comprising a subcellular proteome, introducing said homogenate to a density gradient within a continuous-flow ultracentrifuge, applying a centrifugal force to said homogenate such that the first and second organelles migrate within the density gradient, removing said first and second organelles from said density gradient, solubilizing the subcellular proteomes of the first and second organelles, detecting said translocation protein in the first and second organelles of the first biological sample, measuring the level of detected translocation protein in the first and second organelles of the first biological sample, determining the relative amounts of said translocation protein in said first and second organelle of a second biological sample, said second biological sample being isolated at a second time point and repeating the above steps; and analyzing said translocation process of said translocation protein as said function of time by comparing the measured levels of said detected translocation protein in the first and second organelles for each of said biological samples isolated at each of said time points.

In yet another embodiment of the invention, a method is provided for obtaining proteins from subcellular organelles and sub-types thereof, having the steps of: a) releasing the subcellular organelles and sub-types thereof from a biological sample; b) introducing the subcellular organelles and sub-types thereof to a density gradient within a continuous-flow ultracentrifuge; c) applying a centrifugal force such that the subcellular organelles and sub-types thereof migrate and accumulate within the density gradient in a single run; and d) collecting the subcellular organelles and sub-types thereof from the density gradient and obtaining the proteins therefrom.

These and other embodiments of the invention are provided in or are obvious from the following detailed description of the invention.

### BRIEF DESCRIPTION OF THE DRAWINGS

The following detailed description given by way of example, but not intended to limit the invention solely to the specific embodiments described, may best be understood in conjunction with the accompanying drawings in which:

FIG. 1 is a flow chart depicting the method of separation and accumulation of organelles. an embodiment of the invention.

FIG. 2 is a flow chart depicting the method of protein characterization and quantitation.

FIG. 3 depicts the percentage of mitochondria, endoplasmic reticulum, Golgi, and plasma membrane in collected fractions for rat liver.

FIG. 4 depicts the enrichment of mitochondria, endoplasmic reticulum, Golgi, and plasma membrane in collected fractions for rat liver.

FIG. 5 depicts the percent (%) integrity for preparations of (1) endoplasmic reticulum (76.3%), (2) mitochondria (72.6%), (3) Golgi bodies (89.3%), and (4) plasma membrane (72.7%).

FIG. 6 depicts transmission electron micrographs comparing the organelle content and ultrastructure of a crude extract sample of rat liver cells and an endoplasmic reticulum fraction as prepared by the method of the present invention.

FIG. 7 depicts the percentage of mitochondria, endoplasmic reticulum, Golgi, and plasma membrane in collected fractions for HeLa cells.

FIG. 8 depicts the enrichment of mitochondria, endoplasmic reticulum, Golgi, and plasma membrane in collected fractions for HeLa cells.

FIG. 9 depicts the level of enrichment of a specific organelle by the method of the present invention.

FIG. 10 depicts the quantitated signals for each fraction shown in FIG. 7.

FIG. 11 depicts the percentage sucrose content for collected post-centrifugation fractions of homogenized and centrifuged HeLa cells.

FIG. 12 depicts a comparison of 2D gel electrophoresis analysis on the crude extract (CE) sample and a fraction of endoplasmic reticulum (ER).

FIG. 13 depicts the results of 2D gel electrophoresis analysis of HeLa cell crude extract, a Golgi fraction, and a plasma membrane fraction.

FIG. 14 depicts the mass spectrometry data for spots 12, 13, and 14 of FIG. 13.

FIG. 15 shows the results of 2D gel electrophoresis analysis of rat liver cell crude extracts and an endoplasmic reticulum fraction.

FIG. 16 shows the results of 2D gel electrophoresis analysis of rat liver cell crude extracts and a mitochondria fraction.

FIG. 17 shows the results of 2D gel electrophoresis analysis of rat liver cell crude extracts and a Golgi fraction.

FIG. 18 shows the results of 2D gel electrophoresis analysis of rat liver cell crude extracts and an plasma membrane fraction.

FIG. 19 shows a flow chart to provide information pertaining to the method of the invention to third parties.

FIG. 20 shows a flow chart to protect intellectual property flowing from the method of the invention.

FIGS. 21A and 21B show results of homology searching using peptide sequences obtained from the method of the invention.

FIGS. 22A and 22B show the detection limit of proteins using 2D-gel analysis and the estimated amounts of biological material required to reach the protein detection limit, relative to the protein copy number. FIGS. 22A and 22B relate to cells and tissues, respectively.

These and other embodiments are disclosed, or are obvious from and encompassed, by the following Detailed Description.

### DETAILED DESCRIPTION

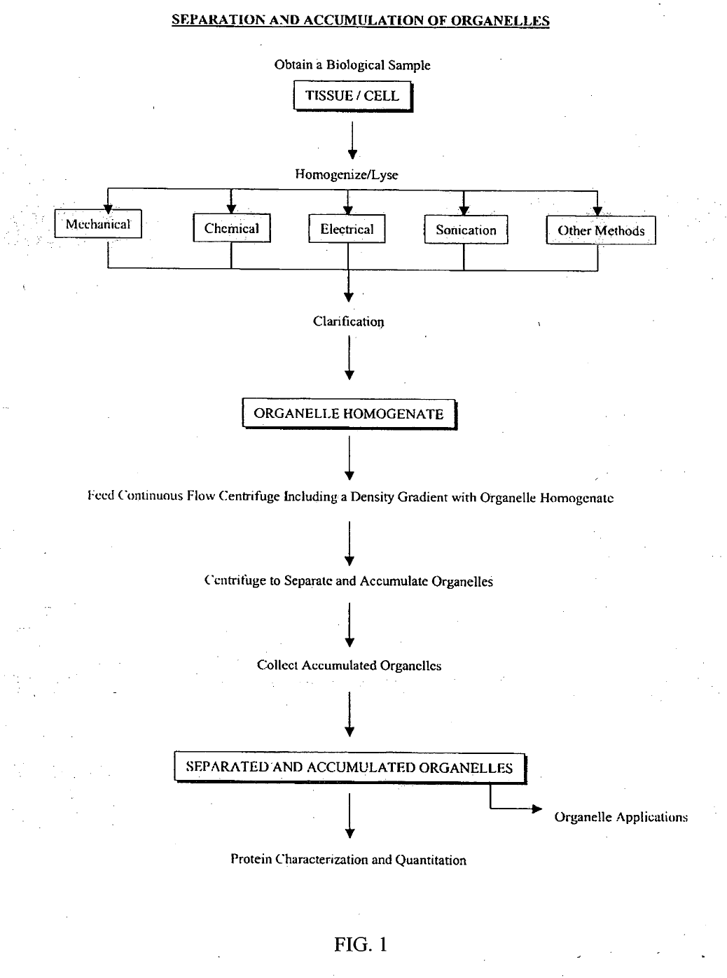

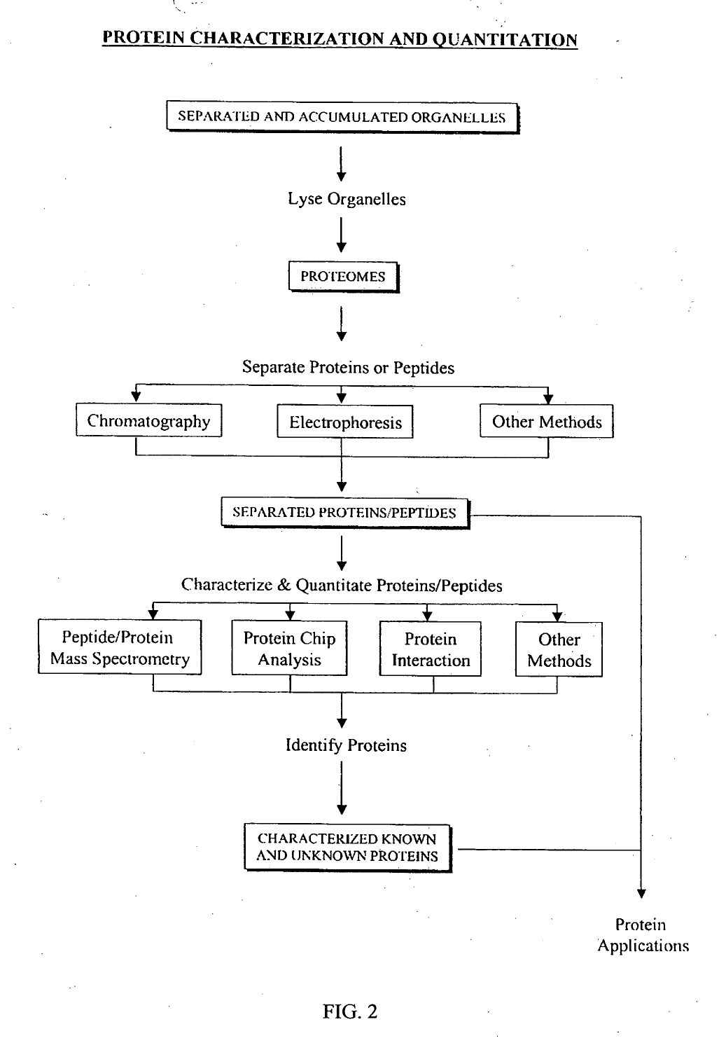

As seen in FIGS. 1 and 2, an embodiment of the invention involves obtaining a biological sample in the form of a tissue or a cell; homogenizing the tissue and/or lysing the cell to provide for a homogenate; optionally clarifying to remove certain material, such as, for example, nuclei; feeding the homogenate into a continuous-flow ultracentrifuge having a density gradient therein; applying a centrifugal force to the homogenate to separate and accumulate intact organelles; collecting the organelles; and using the organelles in further downstream processes. One such downstream process involves obtaining low-abundance proteins from the organelles by lysing the organelles to release the proteome; separating and accumulating the low-abundance proteins therefrom; characterizing, quantitizing and, if possible, identifying the low-abundance proteins; and using the low-abundance proteins in further downstream processes.

Obtaining the sample. As seen in FIG. 1, the method of the invention can be applied to any biological sample known to one of ordinary skill in the art, or any sample comprising a biological sample, isolated or obtained from any source using any method known to the skilled artisan.

For the purposes of the invention, a “biological material,” which can have the same meaning as a “biological sample,” “biological specimen,” or “biological substance,” or any other similar variation known to a skilled artisan, refers to any type of biological material known to one of ordinary skill in the art, including, for example, whole cells, cellular extracts, tissues, homogenized cells or tissues, protein solutions, subcellular structures, such as, for example, organelles and organelle subtypes, or any other material that one of ordinary skill in the art would consider to be a biological material. A biological material can also be any solution, mixture, suspension, substance, buffer, or any of the like, such as, for example, a non-biological solution, such as, for example, a phosphate buffer, that comprises a biological material added thereto, such as, for example, an organelle or organelle subtype. More specifically, a biological material of the invention can be obtained from any known source, living or dead, such as, for example, an organ, bodily fluid, blood, serum, plasma, saliva, tears, feces, urine, semen, mucous, tissue, tissue homogenate, cellular extract, or spinal fluid, derived from any known organism or part thereof or virus, including, but not limited to, for example, any prokaryote or eukaryote; vertebrate or invertebrate; or any organism, such as, for example an animal, a mammal, a human, a bird, a horse, a fish, a rodent, an insect, or plants, etc. or any combinations thereof.

In one embodiment, the biological sample is a cell. A “cell,” in accordance with the present invention, is meant in the ordinary biological sense as the smallest, membrane-bound body capable of independent reproduction. In a broader sense, cells can be either eukaryotic or prokaryotic. In addition, it will be appreciated that a cell can be obtained from a multicellular organism, a tissue, a cell or tissue culture, a virus-infected cell in a cell culture, or from any biological sample. It will be further appreciated that a cell, especially a eukaryotic cell, contains subcellular structures, including, for example, organelles and other subcellular structures.

“Organelle” and “subcellular organelle,” which have the same meaning in the invention, are understood by one of ordinary skill in the art in the ordinary biological sense. An organelle includes any type of complex structure that forms a component of a cell and typically performs a characteristic function. The invention contemplates any organelle from any biological sample known to one of ordinary skill in the art, such as, for example mitochondria, chloroplasts, peroxisomes, Golgi apparatus, endoplasmic reticulum, nuclei, proteosomes, ribosomes, and others, including, any known or unknown sub-types of organelles, such as, for example, smooth and rough mitochondria, early and late endoplasmic reticulum, or any sub-type or sub-population of a particular organelle that would be understood or discoverable by one of ordinary skill in the art.

In accordance with the present invention, an organelle “sub-type” or “sub-population” can refer to a sub-portion of a particular organelle population in a cell that is distinct in some manner from the remainder of the same type of organelles of that same population. For example, organelle sub-types include differences based on, for example, the overall size and shape of the organelle, the density of the organelle, the characteristic protein population that is expressed, the composition of the organelle membrane, or any other physiological or morphological distinction that would be known to the skilled artisan. Some organelles contain membranes, which are called “organelle membranes.”

It is also understood that organelles have, for example, characteristic sets of biomolecules, in particular, characteristic sets of proteins that make up subsets of the whole protein complement of a cell as subsets of the whole proteome of a cell. The subset of proteins associated with a subcellular structure, such as, for example, an organelle, or those proteins forming a subset of the entire protein complement of a cell, tissue, or genome can be referred to as a “subcellular proteome.” In the particular case of an organelle, the subcellular proteome associated with the organelle-specific proteins—those proteins that are contained within and/or directly or indirectly bound, integrated, or attached to the organelle membrane—can be referred to as the “organelle proteome.” An organelle subtype can have a proteome that is unique in its composition such that it can be distinguished from the proteome that is formed from the combination of some or all of each of the remaining sub-types of organelles comprising the organelle.

One skilled in the art will appreciate that the coining of the term “proteome” is generally given credit to Marc Wilkins of Macquarie University (Australia), who defined the proteome as “all proteins expressed by a genome, cell or tissue.” For example, and for the purposes of the present invention, the term proteome refers to the entire protein complement and includes all of the expressed proteins, of a genome, cell, tissue, or organelle. As such, the proteome can be thought of as a dynamic collection of proteins expressed by a genome, cell or tissue that can change in accordance with a variety of different factors, such as, for example, the growth and/or differentiation stage of a cell, internal and external environmental factors, disease factors, and any other factors known to the skilled artisan.

In some cases, it will be appreciated that certain organelles, such as, for example, mitochondria and chloroplasts, contain their own chromosomes which can express some of the proteins associated with the chromosome-containing organelle. However, the skilled artisan will understand that the majority of proteins that constitute an organelle proteome are expressed by the cell's chromosomes and are transported into the organelle of interest vis-à-vis a variety of mechanisms, such as, for example, translocation and vesicular delivery.

For the purposes of the invention, the term “proteomics” refers to the effort to establish the properties including, for example, identities, quantities, structures and biochemical and cellular functions, of all the proteins in an organism, organ, tissue, extracellular space, cell, or organelle, or any combination thereof, and how these properties vary in space, time and physiological state. It will be further appreciated that proteomics investigates the nature of cellular processes through the characterization of the many defining properties and behaviors of proteins, such as, for example, protein expression profiles, post-translational modifications, intracellular localizations, and protein-protein interactions, with a view to space, time, and physiological state. Proteomics includes not only the identification and quantification of proteins, but also the determination of their localization, modifications, interactions, activities, and, ultimately, their function.

Homogenizing/lysing the biological sample. Referring again to FIG. 1, once the biological sample is obtained, the biological sample is homogenized and/or lysed. The product of the homogenization step is typically referred to as a homogenate. A homogenate is meant to have the same meaning as recognized in the art. Thus, a homogenate is the form of the biological sample following homogenization and/or lysing of the biological sample. The process of homogenization and/or lysis is further explained below.

The methods and materials used for homogenization and/or lysis are generally known in the art. In accordance with the present invention, the term “homogenization” and related terms, such as, for example, homogenize or homogenizing, can refer to any of a variety of techniques used by one of ordinary skill in the art to achieve the disruption of tissues into smaller and more uniform components, such as cells and extracellular material comprising the tissue. For example, homogenization of a tissue can refer to the breaking up of the tissue into individual cells such that the cells become separated and/or detached from each other and from any extracellular material. The terms homogenization and/or lysis can also refer to the step of disrupting cells, for example, cells of a tissue, into their subcellular components. Thus, in accordance with the present invention, the homogenized tissues or homogenized and/or lysed cells can result in the release of the subcellular components, including, for example, the organelles. By “release” of intracellular components from the cell, such as, for example, organelles, it is meant that the intracellular components no longer remain confined by a cellular or plasma membrane.

One of ordinary skill in the art will appreciate the variety of approaches available to carry out the disruption of a tissue and/or cell. It will be appreciated that lysis and/or disruption can result in the disruption of the cellular membrane such that the intracellular components, such as, for example, organelles, are released. The homogenization and/or lysis conditions can be adjusted so that the cellular membrane is disrupted while minimizing the disruption of the organelle membranes. Methods for adjusting these conditions to achieve the lysis of the cellular membrane while minimizing the lysis of the organelle membranes are known and can be found, for example, in Current Protocols in Cell Biology (1999), Ed. J. S. Bonifacino et al. and Subcellular Fractionation: A Practical Approach, (1997), Ed. J. M. Graham et al.

The present invention contemplates any technique for homogenizing and/or lysing a biological sample known or that will become available to one of ordinary skill in the art, such as, for example, any chemical-based, mechanical-based, pressure-based, or temperature-based technique. For example, such methods can include applying a liquid shear force to the cells and/or tissue by passing the cells and/or tissue through the narrow annulus of a ball-bearing and a metal block in a syringe (“ball-bearing homogenizer”); forcing the cells and/or tissue under high-pressure through a small orifice; exposing cells and/or tissue to nitrogen gas under high pressure and then forcing through a needle valve, such as, for example, a syringe valve; sonicating the cells to disrupt the cell membrane; contacting the cells and/or tissues with detergents, such as, for example, Tween-20 or sodium dodecylsulfate (“SDS”); contacting the tissue and/or cells with a solution that provides osmotic stress, such as, for example, an isoosmotic medium, hypoosmotic medium, such as, for example, a sucrose solution of 0.1 Molar; and applying shear forces, such as, for example, introducing the tissues and/or cells into a tissue blender (such as a Waring™ blender, Waring Laboratory, CT); or any combination of the above methods or any other additional methods known to the skilled artisan.

One of ordinary skill in the art will appreciate that specific sources and/or types of tissues from any biological material (such as, for example, heart, pancreas, glands, muscle, bone, kidney, skin, liver, lung, brain, or blood, or other organ, and specific sources of cells, including, for example, tissue culture cells, cell culture cells, or any type of cell in suspension) can be homogenized in accordance with a technique or procedure that is designed for a particular tissue and/or cell. For example, liver cells may have a homogenization method that is designed for the homogenization or lysis of that particular type of cell. Information on the many techniques of cell and tissue homogenization and/or cell lysis can be found in commercially-available handbooks, such as, for example, Sambrook J. et al., Molecular Cloning: a Laboratory Manual, 2^{nd} edition, 1989, Cold Spring Harbor Laboratory Press.

The term “substantially intact” refers to the relative degree of integrity of the subcellular components, especially the organelles, at any point during the method of the invention, including the point at which the organelles are released from the cells and/or tissues following homogenization and/or lysing or during or after the continuous-flow process, such as, for example, the continuous-flow centrifugation process, or at any other point during the method of the invention. Whether the organelles are substantially intact can be determined by any known method to one of ordinary skill in the art, such as, for example, by quantitative enzymatic assays of organelle-specific markers, Western blots to organelle-specific markers, or by visual inspection using microscopy, such as, for example transmission electron microscopy (TEM). In the use of microscopy, the skilled artisan will appreciate the morphological characteristics and features of any and all types of organelles from any biological source and/or cell or tissue type and will understand how to judge whether a given organelle is intact based on the particular morphological characteristics.

In one embodiment, organelle integrity can be enzymatically measured. For example, an organelle preparation of interest, such as, for example, a preparation of mitochondria according to the inventive method, can be centrifuged to pellet the insoluble portion, which can comprise intact organelles and portions thereof, such as, for example, organelle fragments. The supernatant contains any soluble components, including any soluble proteins and/or enzymes, released from a fragmented organelle of interest. Next, the relative levels or quantities of an organelle-specific marker, such as, for example, an enzyme that is particular to a given organelle of interest, can be measured with respect to both the organelle pellet and the remaining supernatant fraction. It will be appreciated that the pelleted organelles may have to be lysed prior to measuring or detecting the organelle-specific marker.

One of ordinary skill in the art will appreciate that different subcellular organelles will have different and distinct “organelle-specific markers” that can be detected, assayed or probed with an antibody in order to determine the enrichment factor of a particular organelle. For example, cytochrome-c oxidase and/or Tom20 (18 kDa) can be used to detect mitochondria; beta-hexosaminidase and/or beta-galactosidase can be used to detect lysosomes; peroxidase can be used to detect endosomes; alkaline phosphodiesterase I and/or NaKATPase (150 kDa) can be used to detect plasma membrane; alpha-mannosidase II and/or GM130 (130 kDa) and/or P115 (115 kDa) can be used to detect the Golgi apparatus; catalase can be used to detect peroxisomes; lactate dehydrogenase can be used to detect the cytosolic fraction; and RNA and/or BiP/GRP78 (78 kDa) can be used to detect rough endoplasmic reticulum. Preferably, antibodies against mitochondrial-specific Tom20 (18 kDa), endoplasmic reticulum-specific BiP/GRP78 (78 kDa), plasma membrane-specific NaKATPase (150 kDa), Golgi-specific GM130 (130 kDa), and Golgi-specific P115 (115 kDa) can be used to detect and quantify the presence of the specific organelles in the fractions of the centrifuged biological samples of the present invention using any suitable means known to the skilled artisan, such as, for example, Western blotting and immunoblotting. These antibodies can be obtained from commercial sources, such as from BD BIOSCIENCES (CA), STRESSGEN (Victoria, BC Canada), and from academia.

Thus, integrity is assessed by separating an organelle preparation into soluble (supernatant) and insoluble (solid pellet) fractions, assaying or detecting an organelle-specific marker in both fractions, and then comparing the relative levels or quantities from both fractions. Generally, it will be appreciated that the higher relative level of quantity of the organelle-specific marker contained in the insoluble fraction (as compared to the soluble fraction) corresponds to a higher degree of organelle integrity. Preferably, the invention contemplates equal to or greater than about 60%, 70%, 80% or over 90% intactness of the organelles at any stage of the inventive method prior to the stage of lysing the organelles.

In one embodiment, organelle integrity can be calculated by dividing the relative quantity of the organelle-specific marker measured for the insoluble fraction by the sum of the relative quantities of organelle-specific marker in both fractions multiplied by 100 to yield a percent (%) intactness (or integrity). For example, a preparation of mitochondria can be centrifuged to form a pellet of mitochondria (and fragments of mitochondria such as those mitochondria that have been disrupted and/or lysed thereby releasing the intra-organelle soluble materials, such as, for example, soluble mitochondrial proteins, including a mitochondrial-specific marker) and a supernatant comprising soluble components of disrupted and/or lysed organelles. The relative level of mitochondrial-specific protein and/or enzyme (mitochondrial marker, such as Tom20) can then be determined for both the soluble and the insoluble fractions. Percent integrity can then be calculated by dividing the quantity of mitochondrial marker in the insoluble fraction by the sum of the mitochondrial marker quantities of both the insoluble and soluble fractions multiplied by 100 to obtain a percentage that reflects the relative portion of the mitochondrial preparation containing intact mitochondria.

It will be appreciated by the skilled artisan that a buffer is generally used during the homogenization process. The invention contemplates any suitable buffer known to one of ordinary skill in the art including, for example, detergents, such as, for example, Triton-X, sodium dodecylsulfate (SDS), and the like, salts, such as, for example, sodium chloride, proteinases, such as, for example, proteinase K, inhibitors of DNA and RNA degrading enzymes, and any other additional components suitable for use in a homogenization buffer. The skilled artisan will appreciate that the composition of the buffer can depend on the type and/or source of biological sample.

Optional clarification step. Referring again to FIG. 1, a cell and/or tissue homogenate of the biological sample, wherein the homogenate comprises intact organelles, is typically “clarified” to remove certain intracellular components, such as nuclei. Nuclei, typically blockother components in a sample, such as, for example, other organelles, from entering the gradient. Thus, the nuclei can be removed from the sample prior to the continuous-flow centrifugation process of the invention.

Any method suitable for the removal of the nuclei is contemplated by the instant invention, including, but not limited to, centrifugation. For example, to clarify a homogenate using a centrifuge, any centrifuge known to one of ordinary skill in the art, such as a batch or analytical centrifuge at an appropriate relative centrifugal force (RCF) (×g), such as, for example from about 500×g to about 40,000×g can be used. The centrifuge separates, for example, the nuclei by applying a centrifugal force to the homogenate to cause the nuclei, but not the remaining organelles, to migrate towards one end of the centrifuge tube, for example, towards the bottom of a centrifuge tube. In one embodiment, a low-speed clarification centrifuge known in the art can be used to clarify the homogenate. The low-speed clarification centrifuge can be a continuous-flow centrifuge.

Centrifuge. As seen in FIG. 1, once the biological sample is homogenized and/or the cell is lysed, the homogenate and/or product derived therefrom is introduced to a density gradient within a continuous-flow centrifuge.

For the purposes of the present invention, a “continuous-flow centrifuge” is a type of centrifuge or ultracentrifuge that can have a rotor with an inlet and generally an outlet wherein a sample material can be introduced into the rotor through the inlet, allowed to contact a gradient while in the rotor, and allowed to exit through the outlet. A continuous-flow centrifuge can encompass a semi-continuous-flow centrifuge.

Any known configurations of the continuous-flow centrifuge and the continuous-flow centrifuge rotor are contemplated by the present invention. For example, the continuous-flow rotor can have an inlet or an inlet and an outlet such that a sample can be continuously or intermittently introduced through the inlet and continuously or intermittently released through the outlet. The rotor can also have an inlet without an outlet, allowing the sample to be continuously introduced into the rotor, but not continuously released. Where the rotor is spinning, a gradient can be pre-formed or pre-established. The sample that is released from the outlet can also be continuously or intermittently recirculated or reintroduced into the rotor through the inlet to provide multiple “passes” of the sample material over the gradient. The invention contemplates any number of passes over the gradient sufficient to enrich and accumulate the organelles.

The gradient can be removed from the rotor of the continuous-flow centrifuge at the end of a run while the rotor continues to spin. In its place, a fresh gradient material can be added into the moving rotor. Once the new gradient is established in the rotor, another biological sample, such as the homogenate of another biological sample, can be introduced into the rotor and allowed to contact the gradient. In this sense—where the operation of the continuous-flow centrifuge is such that a first gradient, having a first biological sample separated therein, is removed while the rotor is spinning or rotating and replaced with a fresh volume of gradient material while the rotor continues to spin for the separation of a second biological sample—is termed “continuous-flow mode.” Continuous-flow mode is not limited to adding and removing only a first and second gradient, but rather, any number of gradients can be successively added and removed from the centrifuge rotor to separate any number of biological samples in succession all while the rotor continues to spin, e.g., without having to shut down or stop the rotor of the centrifuge.

The invention further contemplates that a biological sample of the invention, such as a homogenate of a biological sample, can be loaded into the continuous-flow centrifuge in a manual, automatic, or semi-automatic manner. For example, a robotics system, including any appropriate sensors or electronics, can be employed in a suitable manner to achieve the automatic or semi-automatic loading of the biological sample into the rotor of the continuous-flow centrifuge. In addition to the loading of the biological sample, the gradient material can also be loaded into the rotor of the continuous-flow centrifuge in a manual, automatic or semi-automatic manner and can employ any suitable robotics, sensors, electronics, or computers systems and/or software for the controlling and/or programming of the automated or semi-automated systems.

Examples of suitable continuous-flow centrifuges are those manufactured by Alfa Wassermann, Inc. (West Caldwell, N.J.) including, but not limited to, models KII, PKII and RK Some representative rotor models include, but are not limited to, AW K3-3200, AW PK3-1600, AW PK3-800, AW PK3-400, AW PK3-200, and AW PK3-100. Rotors of higher and lower volume are contemplated to fall within the scope of the invention.

Other continuous-flow centrifuges can be utilized by the invention. These include, for example, Beckman CF32Ti, Beckman JCF-Z-standard core, Beckman JCF-Z small pellet core, Beckman JCF-Z large pellet core, Beckman Z60, Sorvall SS34/KSB, Sorvall TZ-28/GK, Sorvall TCF-32 (P32CT with 940 ml core), Sorvall TCF-32, and those manufactured by Hitachi, such as, for example, centrifuges CC40, CP40Y, C40CT2-H, C40CT and CP60Y. The Hitachi centrifuges are distributed by Kendro.

In another embodiment, the continuous-flow ultracentrifuge is a rate zonal ultracentrifuge. Zonal rotor assemblies have been used for many years and considerable literature is available on the subject. Information about zonal rotors is included in most purification handbooks and biochemistry texts. Specific information can be found in Anderson, An Introduction to Particle Separations in Zonal Centrifuges (National Cancer Institute Monograph No. 21, 1966); Anderson, Separation of Sub-Cellular Components and Viruses by Combined Rate and Isopycnic Zonal Centrifugation (National Cancer Institute Monograph No. 21, 1966); and, Anderson, Preparative Zonal Centrifugation, in Methods of Biochemical Analysis (1967), all of which are incorporated herein by reference.

For the purposes of the invention, a centrifuge “run” refers to the moment when a sample is added to a rotor, either with the rotor already in motion and having a preformed gradient or with the rotor stopped, until the sample is processed by the centrifuge, including any number of passes, for example, one pass (no recirculation of sample), two passes (sample is recirculated once), three passes (sample is recirculated twice), etc. The passes can be carried out such that the rotor is not stopped or slowed. Further, the sample can also be continually recirculated for any period of time. It is also contemplated that a centrifuge run can occur at a constant or variable speed.

In an embodiment, the centrifuge run utilized by the invention can be a single run. For example, the migration, separation and accumulation of the subcellular organelles and subtypes thereof are performed in one centrifuge run.

Typically, preparation for and conducting a continuous-flow ultracentrifuge run is either manually performed, automated, for example, by a computer, or a combination of both manually performed and automated. Preferably, computers and software are utilized for controlling the centrifuge and calculating a centrifugation protocol. Such computers and software provide the operator with operating parameters displayed in “real-time” on a control screen. Automated programs can also be run from pre-stored files, or manually through a control screen.

In an embodiment, during each centrifuge run, on-line data monitoring and recording of set parameters, run parameters, and alarm status are made and are down-loaded to the system memory. Such downloading may also be directed to an external data storage location.

A separation protocol, computer-automated, manually-performed, or a combination of both, typically involves manipulation of a number of variables. Such variables include, for example, the physical characteristics of the target organelle; formation of the gradient; and the calculation of run parameters.

The physical characteristics of the target organelle useful for defining a separation protocol include, for example, the sedimentation coefficient (S_{20ω}) and buoyant density of the target organelle. Such values are useful, for example, for reducing the number of trial and error experiments. (See, Rickwood et al., Centrifugation Essential Data, BIOS Scientific Publishers Limited 1994, Publisher J Wiley & Sons; Preparative Centrifugation: A Practical Approach, Edited by D Rickwood, Oxford University Press 1921; and Methods in Enzymology, Vol. 182: Guide to Protein Purification, Edited by Murray P. Deutscher, Academic Press 1990).

The separation protocol also typically involves knowledge of the gradient. A gradient can include, but is not limited to, a density gradient. The density gradient, in turn, can be, for example, a continuous gradient, a discontinuous gradient or a step gradient. The choice of gradient material depends on, for example, the product, impurity stabilities and product densities. Commonly used gradient materials include any suitable gradient material known to one of ordinary skill in the art and that can be obtained commercially or prepared by the skilled artisan. Gradient materials include, but are not limited to: an alkali metal solution, such as, for example, cesium chloride (CsCl), cesium sulfate (Cs₂SO₄), potassium tartrate, or potassium bromide; nonelectrolyte solutes, such as, for example, sucrose, mannitol, or glycerol; polysaccharides, such as, for example, Ficoll® 400 (Pfizer, Conn.); iodinated nonelectrolytes, such as, for example, metrizamide, Nycodenz® (Nycomed, Inc., NJ), Iodixanol®, or Optiprep®; Percoll® (colloidal silica coated with polyvinylpyrrolidone) (Pfizer, Conn.), or any other suitable material known to one of ordinary skill in the art.

It will be appreciated that the gradients comprised of alkali metals, although corrosive, can create high densities with low viscosity. For example, cesium chloride, which is frequently used as a gradient material, can achieve high density that is typically up to approx. 1.9 g/cm³. In another example, potassium bromide can also form high densities, but only at elevated temperatures, e.g. 25° C. Such elevated temperatures may be incompatible with the stability of the proteins of interest.

Examples of gradients mentioned above include Nycodenz®, Optiprep®, Iodixanol® and sucrose. Sucrose is a cost-effective gradient material and utilizes a sufficient density range for most operations (up to approx. 1.3 g/cm³). The viscosity of a sucrose gradient allows for the formation of a steep gradient used for banding product, or, alternatively, to create a wide product capacity in the same rotor. The steep gradient is typically efficient for a continuous flow operation if, for example, entry of the non-target protein is to be minimized. The viscosity of sucrose is also a desirable attribute to forming steep gradients for long periods of time in a continuous flow rotor. By contrast, a low-viscosity solution, such as CsCl, may need the addition of a higher-viscosity material, such as glycerol, to increase viscosity and minimize gradient erosion during a continuous-flow run.

The invention contemplates using any type of gradient having any concentration profile. The “concentration profile” will be known by the skilled artisan as the variation in the concentration of the gradient medium or material along a path perpendicular to the gradient in the horizontal, vertical, diagonal, or any direction there-between. As such, the gradient can be a “linear gradient,” a “convex gradient,” a “concave gradient,” or a “discontinuous gradient,” or any other suitable form known to the skilled artisan.

Sucrose is a preferred density gradient material. Table 1 describes the theoretical separation requirements for the separation of mitochondria, endoplasmic reticulum, plasma membrane, and Golgi apparatus contained in a homogenized biological sample using sucrose density gradients.

TABLE 1
Theoretical separation requirements for homogenized biological sample.

| | | Banding in | | Separation |
|---|---|---|---|---|
| Component | Amount | Sucrose* | Density range | Condition |
| Mitochondria | 16% of cell protein | 42.5% | 1.19 g/cm³ | 5,000 × g, 10 min |
| | 16% of cell protein | | 1.17-1.21 g/cm3 | 10,000 × g 25 min |
| Endoplasmic | 5% of cell protein | 37%*** | 1.16 g/cm³*** | 100,000 × g, 120 min |
| Reticulum | 24% of cell protein | | 1.06-1.23 smooth | 150,000 × g 50 min |
| | | | 1.18-1.23 rough | |
| Plasma | 2% of cell protein | 37% | 1.16 g/cm³ | 80,000 × g, 60 min** |
| Membrane | 0.4-2.5% of homogenate | | 1.12-1.14 | 100,000 × g 60 min |
| Golgi | 1% of cell protein | 33 to 36%** | 1.14 to 1.15 g/cm³ | 100,000 × g, 55 min |
| | | | 1.12-1.16 | 150,000 × g 20 min |

*Derived from the density data using sucrose tables
**based on a step gradient
***based on banding similarity to plasma membrane

As described above and defined herein, a continuous-flow centrifuge run can include a number of passes. For example, a homogenized biological sample can be passed twice through the continuous-flow centrifuge of the invention. The first pass can be carried out at 20,000 RPM in a PK-3-800 rotor using a flow rate of 20 ml/min (1.2 L/hr). As such, the materials over 487 Svedberg's (S) are expected to enter the gradient. The following parameters can be used for the first run:

| | | |
|---|---|---|
| G force core | 24,379 | × g |
| bowl | 29,562 | × g |
| K factor | 121.94 | |
| Time to pellet | 15.00 | min |
| Transient time | 20.00 | min |
| Svedberg value | 487 | S |

The second pass in turn can be carried out 40,000 RPM. As such, the materials over 122S were expected to enter the gradient. The following parameters can be used for the second run:

| | | |
|---|---|---|
| G force core | 97,515 | × g |
| bowl | 118,250 | × g |
| K factor | 30.49 | |
| Time to pellet | 15.00 | min |
| Transient time | 20.00 | min |
| Svedberg value | 122 | S |

Alternatively, the second pass can be carried out at 35,000 RPM in a PK-3-800 rotor using a flow rate of 20 ml/min (1.2 L/hr). As such, the materials over 159S are expected to enter the gradient. The following parameters can be used for such an alternative pass:

| | | |
|---|---|---|
| G force core | 74,660 | × g |
| bowl | 90,535 | × g |
| K factor | 39.82 | |
| Time to pellet | 15.00 | min |
| Transient time | 20.00 | min |
| Svedberg value | 159 | S |

The length of time used to carry out the centrifugation at a particular RPM value determines whether a particular material will pellet out, which in turn, typically depends on the Svedberg value of the material. For example, using the PK-3-800 rotor at 35,000 RPM, the material over 53S typically pellets out in 45 minutes. In the case of 120 minutes, the material over 19.9S typically pellets out. In both instances, the RCF values at the core and bowl would be 74,660×g and 90,535×g, respectively.

Based on the known theoretical sedimentation ranges of the organelles, for example, mitochondria, plasma membrane, endoplasmic reticulum, and Golgi apparatus, as shown below, the time required for pelleting can be estimated. For example, the known sedimentation ranges of mitochondria, plasma membrane, endoplasmic reticulum, and Golgi apparatus are as follows: 10,000 to 50,000 S; 50 to 1,000 S and 100,000 to 500,000 S; 1 to 5,000 S; and 1,000 to 10,000 S; respectively.

The time needed to pellet out an organelle at different speeds can be determined. For example, based on centrifugation at 20,000 RPM in the PK-3-800 rotor at a 20 ml/min sample flow rate, the times to pellet the following components are shown in the following table:

| Component | Svedberg constant | | Time to pellet (min) | Capture rate |
|---|---|---|---|---|
| Mitochondria | 10 000 | S | 0.73 | 100% |
| Mitochondria | 50 000 | S | 0.15 | 100% |
| P.M. | 50 | S | 146.33 | 0% |
| P.M. | 1 000 | S | 7.32 | 100% |
| P.M. | 100 000 | S | 0.07 | 100% |
| P.M. | 500 000 | S | 0.01 | 100% |
| E.R. | 1 | S | 7316 | 0% |
| E.R. | 5 000 | S | 1.46 | 100% |
| Golgi | 1000 | S | 7.32 | 100% |
| Golgi | 10 000 | S | 0.73 | 100% |

At 35,000 RPM in turn, the times to pellet the following components in a PK-3-800 rotor at a 20 ml/min sample flow rate are as follows:

| Component | Svedberg constant | Time to pellet (min) | Capture rate |
|---|---|---|---|
| P.M. | 50 S | 224.29 | 0% |
| E.R. | 1 S | 11214 | 0% |

Alternatively, at 40,000 RPM, the times to pellet the following components in a PK-3-800 rotor at a 20 ml/min sample flow rate are as follows:

| Component | Svedberg constant | Time to pellet (min) | Capture rate |
|---|---|---|---|
| P.M. | 50 S | 36.58 | 0% |
| E.R. | 1 S | 1829 | 0% |

The time to band a particular component having a particular Svedberg constant can be determined. For example, predictions can be made based on centrifugation at 35,000 RPM using a first pass of 45 min and a second pass of 120 min in a PK-3-800 rotor as seen in the table below. The table also shows whether the banding is completed after the 45 min and 120 min passes.

| | | | Time to band | Banding complete |
|---|---|---|---|---|
| Component | Svedberg constant | | (min) | 45 min/120 min |
| Mitochondria | 10 000 | S | 0.24 | Yes/Yes |
| Mitochondria | 50 000 | S | 0.05 | Yes/Yes |
| P.M. | 50 | S | 47.78 | No/Yes |
| P.M. | 1 000 | S | 2.39 | Yes/Yes |
| P.M. | 100 000 | S | 0.02 | Yes/Yes |
| P.M. | 500 000 | S | 0.005 | Yes/Yes |
| E.R. | 1 | S | 2389 | No/No |
| E.R. | 5 000 | S | 0.48 | Yes/Yes |
| Golgi | 1000 | S | 2.39 | Yes/Yes |
| Golgi | 10 000 | S | 0.24 | Yes/Yes |

In one embodiment, the continuous-flow ultracentrifuges contemplated herein can be used with different size rotors with differing geometries so as to provide for a scalable separation. For example, the continuous-flow ultracentrifuge of the invention can be configured with different size rotors, such as, for example, a 15-inch or 30-inch rotor. It will be appreciated that the geometry of the rotor used in the instant invention can affect the volume of the sample that can be processed, the narrowness of the sedimentation path, and the total resistance time required for separation. Further, the continuous-flow ultracentrifuge rotors contemplated by the invention can operate in a “reorienting gradient pattern” wherein the gradient moves from loading position (horizontal position) to operational position (vertical position) and back to the loading position to allow for product collection. During use of the rotors contemplated by the invention, the flow path of the sample material can enter the rotor at either end (top or bottom end) through a center port of the core, which then can flow through long thin tubular shafts to exit at attached product lines or tubes.

In another embodiment, a scale separation is performed using the same rotor length but changing the configuration of the rotor core to either reduce or increase volume. For example, as described in co-pending U.S. application Ser. No. 09/995,054, incorporated herein by reference, the method typically involves using cores of different designs, such as those having radially projecting “fins.” In an embodiment, varying the dimensions of the fins modulates the volume displaced by a rotor core. For example, scale down is usually achieved by maximizing the fin size, thereby reducing the volume available for a centrifuge run. Scale up, in turn, is typically obtained by minimizing the fin size, thereby allowing for more volume in the centrifuge run.

In order to carry out a scale separation utilizing different sized rotors, such as those manufactured by, for example, Alfa Wassermann, Inc., a number of parameters are typically considered. These parameters include, but are not limited to, the Rₘₐₓ of the bowl, Rₘᵢₙ of the core, ×g-force at the bowl, ×g-force at the core, time to pellet, transient time, K factor and sample flow rates. Such parameters can depend upon the Svedberg value of a particle being separated.

For example, the separation parameters for a particle of 1,000 S are described below for a rotor, such as those manufactured by Alfa Wassermann, Inc. The rotor Rₘₐₓ (maximum radius) in centimeters, rotor Rₘᵢₙ (minimum radius) in centimeters, and the ultracentrifuge (UCF) rotor maximum speed (rpm) are typically known and are specified by the manufacturer of the rotor and are incorporated herein by reference. Its also known to a skilled artisan that the rotor volume (ml) and the maximum flow rate (L/hr or ml/min) of the rotor are readily available from the manufacturer and are incorporated herein by reference.

A parameter that is calculated is the rotor relative centrifugal force (RCF) (×g). (see Rickwood, 1994). RCF can be calculated using the following equation: RCF=11.18×R× (Q/1,000)², where RCF=relative centrifugal force (×g), R=radius (cm), and Q=speed (revolutions per minute). For example, a particle of 1,000 S can be separated in a PK3-800 rotor based on the following parameters: Rₘₐₓ 6.6 cm, Rₘᵢₙ 5.45 cm, Rotor maximum speed 40,500 rpm. The calculation is as follows:
RCF=11.8×6.6×(40,500/1,000)²
RCF=73.788 1,640.25
RCF=12,1030.76×g
RCF=121,000×g

Likewise, for a rotor having a Rₘᵢₙ value of 5.45 cm, the RCF can be calculated as 99,900×g.

Another parameter that is calculated is the duration of the run, which is a function of the K factor. The duration of the run is typically referred to as “run time” or “time to sediment.” In order to determine the duration of the run for a 1,000 S particle, the K factor of the rotor can be determined from the literature or calculated as follows:

$$K = \begin{matrix} & \underline{2.53 \times {10}^{11}} & & {L}_{ N} ( {R}_{ MAX} / {R}_{ MIN} ) \\ & {Q}^{ 2} & & \end{matrix}$$

For example, the K factor of a PK3-800 rotor (Rₘₐₓ 6.6 cm, Rₘᵢₙ 5.45 cm) for a 1,000 S particle and a rotor maximum speed of 40,500 RPM can be calculated as follows:

$$K = \begin{matrix} & \underline{2.53 \times {10}^{11}} & & {L}_{N} ( 6.6 / 5.45 ) \\ & 40 {500}^{2} & & \end{matrix}$$

$$K = \begin{matrix} & \underline{2.53 \times {10}^{11}} & {L}_{N} ( 6.6 / 5.45 ) \\ & 40 {500}^{2} & \\ & 154.244 & 0.19145\end{matrix}$$

$$K = \qquad 29.53 .$$

K can be also calculated for alternate speeds. For example, at speeds of 35,000 rpm or 20,000 rpm, the following formula is typically used:
K_{new}=K(Qₘₐₓ/Q_{new})²

Qₘₐₓ—rotor maximum speed (revolutions per minute)

Q_{new}—new set speed (revolutions per minute).

Thus, to calculate the K factor at a speed of 20,000 rpm:
K_{new}=K(Qₘₐₓ/Q_{new})²
K_{new}=29.53(40500/20000)²
K_{new}=29.53×4.100
K_{new}=121.

Similarly, the K factor for the set speed of 35,000 rpm is calculated as 39.

Upon determination of the K factor, the run time can then be calculated. For example, sedimentation time (T) can be calculated as follows:
T=K/S

T—time to sediment (hours)

S—sedimentation coefficient (S).

Thus, for a 1,000S particle centrifuged in the PK3-800 rotor at a speed of 20,000 rpm, the run time can be calculated as follows:
T=K/S
T=121/1000
T=0.121 hours
T=7 m 16 s.

In another embodiment, the run time can be calculated in an alternative manner. More specifically, the following formula can be used to determine the run time for a second rotor in a scalable centrifuge run:
Tᵣₒₜₒᵣ₂=Tᵣₒₜₒᵣ₁×(Kᵣₒₜₒᵣ₁/Kᵣₒₜₒᵣ₂),
wherein Tᵣₒₜₒᵣ₁ is the sedimentation for a first rotor, Tᵣₒₜₒᵣ₂ is the sedimenation time for a second rotor, Kᵣₒₜₒᵣ₁ is the K factor for the first rotor, and Kᵣₒₜₒᵣ₂ is the K factor for the second rotor.

Yet another parameter that can be calculated is the sample flow rate. The sample flow rate is a function of the sedimentation time (T) and is calculated as follows:
F=V_{F}/T

F—flow rate (L/hr)

V_{F}—flow through volume (L)

T—time to sediment

The PK3-800 rotor typically has a 50% flow through volume. Thus, for a 1,000S particle running at 20,000 RPM, the flow rate can be calculated as:
F=V_{F}/T
F=0.4/0.121
F=3.3 L/hr
F=55 ml/min.

During a centrifuge run in an embodiment of the invention, the organelles become enriched and are accumulated (wherein accumulated can also mean amplified) within the density gradient. In one embodiment, at least two or more types of organelles and/or subtypes thereof are enriched and accumulated in a density gradient by a continuous-flow ultracentrifuge. In another embodiment, the at least two or more types of organelles are accumulated until the gradient becomes saturated with the at least two or more types of organelles. The continuous-flow method of the invention advantageously accumulates the at least two or more types of organelles and/or subtypes thereof in a quantity sufficient to isolate and identify, for example, low-abundance proteins, known and/or unidentified, that are present in the at least two or more types of organelles and/or subtypes thereof. The continuous-flow method of the invention also advantageously allows for the accumulation and enrichment of large amounts of specific subtypes of organelles having a less complex proteome in relation to the entire proteome of the population of an organelle in the biological sample.

For the purposes of the present invention, “enrichment” is defined as an increase in fold (e.g., 1.1×, 2×, 5×, 10×, 50×, etc.) of an organelle or protein thereof at a location in a gradient, as measured under normalized conditions, relative to the same organelle or protein in a biological sample. In more general terms, enrichment relates to the increase in the relative quantity of an organelle or a plurality of organelles in a particular gradient fraction as compared to the relative amount of the same organelle or plurality of organelles in the original biological sample. Enrichment is also a form of purification of two organelle populations in the homogenate in that it separates organelle types into discrete sections of the density gradient that correspond to the density of the organelle type.

A common approach for determining the enrichment of an organelle or protein thereof at a specific location in a gradient, in particular, at a specific gradient fraction, is to perform Western analysis on an organelle-specific marker, such as any of those previously mentioned. In particular, Western analysis is typically carried using normalized quantities (e.g., standardized and/or comparable amounts of materials) of both the gradient fraction of interest resulting from the separation and accumulation method of the invention and of the corresponding original biological sample. Enrichment is then calculated by dividing the relative amount of the measured organelle-specific marker in the gradient fraction of interest to the amount in the corresponding original biological sample.

For example, and as a first step, the total protein concentrations of the gradient fraction of interest and the original corresponding biological sample are normalized using art-recognized techniques, such as, for example, a Bradford or Lowry protein assay. Reagents and materials for such assays can be prepared by the skilled artisan in accordance with known procedures (e.g., Current Protocols in Biochemistry, John Wiley & Sons, Inc., 1999, Edited by Juan S. Bonifacino) or purchased from commercial sources (e.g., QIAGEN, INC., CA). The determination of the total protein concentrations of both the gradient fraction and the original biological sample includes the step of solubilizing the proteins, especially the insoluble proteins therein, such as, for example, membrane proteins. The solubilizing step typically includes, for example, a suitable detergent, such as SDS or Triton-X. Once the proteins are solubilized in each of the samples, the insoluble material, such as residual membrane material and/or debris, is pelleted by centrifugation and the remaining supernatant, which contains the solubilized proteins, is removed. The protein concentration of the supernatant is then measured using standard methods, such as the Bradford and Lowry assays mentioned above.

As a second step, comparable amounts—which can be equivalent—of the supernatant of the gradient fraction and the corresponding original biological sample are separately electrophoresed in the same or in different apparatuses using a suitable protein-separation material, such as, for example, polyacrylamide. Typically, one-dimensional polyacrylamide gel electrophoresis is used.

The separated proteins are transferred by the art-recognized technique of blotting to a suitable support medium (.e.g., “blot paper”), such as, for example, nitrocellulose. Next, the relative quantities of the organelle-specific marker can be determined by the art-recognized technique of Western analysis. Typically in Western analysis, a primary antibody specific to the organelle-specific marker is allowed to react with the separated proteins on the blot paper over a suitable period of time wherein the primary antibody will bind to the organelle-specific marker in an amount that is directly proportional to the amount of organelle-specific marker present on the blot.

The relative amount of primary antibody is then measured by any suitable means, such as, for example, introducing and detecting a secondary antibody specific for the first antibody. The primary and/or secondary antibodies can be covalently linked to a detectable moiety, such as, for example, a fluorescent molecule, an enzyme, or a chromophore. In the case of an enzyme, a detectable enzyme substrate, such as, a chromatogenic or fluorescent substrate, can be used to detect the primary and/or secondary antibody. The amount of primary and/or secondary antibody present on the blot can then be measured and represented in a digital format, such as pixels.

For example, the enrichment of mitochrondria in a mitochondria-containing fraction can be determined by Western blot analysis by measuring the relative quantities of a mitochondrial-specific marker in normalized quantities of protein from the mitochondrial fraction of interest and the corresponding original biological sample. The detection of the mitochondrial-specific marker in the gradient fraction and the original biological sample can be detected vis-à-vis a fluorescently-labeled primary and/or secondary antibody and through the use of digital imaging and/or photography to detect and quantify the fluorescence signals of the antibodies present on the blot. Any art-recognized instrumentation and/or computer software detecting and measuring the strength of the fluorescent signals of the primary and/or secondary antibodies can be used, such as those available from MOLECULAR DYNAMICS, INC (CA).

The number and/or intensity of the digital signal corresponds to the relative amount of primary and/or secondary antibody on the blot, which in turn corresponds to the relative quantity of organelle-specific marker on the blot, which in turn corresponds to the relative quantity of the organelle of interest in the samples. Enrichment is determined as the ratio of the relative amount of the organelle-specific marker measured from the gradient fraction of interest to that measured from the original biological sample.

The organelles become enriched and accumulated during the continuous-flow centrifuge run according to the method of the invention. For example, and as explained above, the density gradient can be established in the rotor of the continuous-flow centrifuge prior to introducing the biological sample. As such, the gradient material can be added to the continuous-flow rotor and then centrifuged at a speed sufficient to establish the gradient. Once the gradient is established, the biological sample can then be introduced into the rotor while the rotor continues to rotate. As described previously, the biological sample is typically a homogenate of a biological sample and contains organelles, cytosol components, and possible membrane fragments. Optionally and prior to introducing the biological sample to the rotor of the continuous-flow centrifuge, the biological sample can be clarified to remove large particulate matter, such as cellular debris and nuclei, as previously explained.

As previously explained, the biological sample can be introduced into the rotating rotor of the continuous-flow centrifuge in a continuous manner. For example, the biological sample is fed into the rotor while the rotor continues to spin. The speed of the rotor can remain constant or it can be increased or decreased while the biological sample is being added. The sample can be introduced into the rotor using any suitable means, including, but not limited to, a peristaltic pump. Further and as explained previously, the introduction of the sample into the rotor can be carried out in any suitable manual, automatic, or semi-automatic manner and can include the use of any suitable robotics and/or computer control systems. Also, any suitable volume of biological sample can be introduced into the rotor, including, for example, any volume that is less, equal to, or greater than the volume of the gradient material in the rotor.

As the biological sample enters and begins to flow through the rotor, it comes into contact with the density gradient therein. The density gradient has a proximal end and a distal end whereby the proximal end is at a lower density than the distal end. Moving from the proximal end of the gradient to the distal end, the gradient increases in density in accordance with a particular density profile. As explained previously, the density profile, which can also be referred to as the concentration profile, of the gradient can be, for example, linear, convex, or concave. The density gradient can also be regarded as comprising different “sections,” where each section has a proximal end at a first density and a distal end at a second density where the second density is greater than the first density.

Whether a particular component of the biological sample enters the gradient is determined by both the physical characteristics of the component as well as the parameters used by the continuous-flow centrifuge. Such physical characteristics, including, for example, the component's sedimentation value and buoyant density, and centrifugation parameters, such as, for example, RCF (×g) at the rotor and flow rate of the biological sample, were previously described herein. The centrifugation parameters, including the RCF (×g) and the flow rate, can be increased or decreased during the operation of the centrifuge to affect the entrance of different components into the gradient. The parameters of the centrifuge, especially the RCF (×g) can be changed throughout the operation of the continuous-flow centrifuge, including during the introduction of the biological sample.

Once a component of the biological sample enters the proximal end of the gradient, the centrifugal force applied to the component by the centrifugation process causes the component to migrate through the density gradient a rate that is dependent, in part, on the physical characteristics of the component, including, the buoyant density and the sedimentation coefficient of the component. The component migrates through the gradient until reaching an isopynic point where it becomes enriched based on its buoyant density.

During the centrifuge run, further biological sample can be introduced into the centrifuge, as described previously, so as to accumulate the components of the biological sample. For example, when mitochondria and subtypes thereof are enriched in a section of the gradient equal to their buoyant densities, addition of more biological sample containing mitochondria and subtypes thereof into the centrifuge results in the accumulation of the mitochondria and subtypes thereof at that section of the gradient.

Collecting organelles. As seen in FIG. 1, once the centrifuge run is completed, the organelles that have migrated into the gradient are collected. Any art-recognized technique for collecting organelles falls within the scope of the present invention. For example, organelles can be collected by removing a volumetric fraction of the gradient, either manually, automatically, or some combination thereof, and stored and/or placed into a vessel, such as, for example, a sample tube. Any suitable fraction volume is contemplated, such as, for example 1/10,000^{th}, 1/1,000^{th}, 1/100^{th}, or 1/10^{th} of the total volume of the gradient, or any other suitable volume thereof. The volumetric fractions can be the same or different volumes. Further, once collected, the different volumetric fractions can be combined together.

The fractions can also be collected on the basis of a specified density range. In one embodiment, a fraction can be regarded as the gradient material between and including a first density point and a second density point, where the first and the second density points are different. For example, one can collect as a fraction, all the gradient material between and including 10% to 15% sucrose. The density of the gradient at a particular fraction can be estimated or measured using a commercially-available refraction index analyzer, for example, DMA 4500, RXA 156, or RXA 170 (ANTON PAAR, GMBH, Austria).

Any other method, automated, semi-automated, or manual, for the collection of gradient fractions is contemplated and within the scope of the present invention. With automated or semi-automated systems for collection of fractions from the gradient, the invention contemplates any suitable robotics system, including any suitable sensors, electronics, or other useful and/or necessary components. An automated or semi-automated system for collecting gradient fractions, which can be referred to as automated or semi-automated fraction collectors, can also be controlled and/or programmed using any suitable software or computer system. The automated and semi-automated fraction collector can be a stand-alone device or, in another embodiment, integrated with the continuous-flow centrifuge as an on-board device.

Analysis of organelles. According to FIG. 1, once the organelles are collected, the organelles are analyzed by art-recognized methods. For example, the organelles in the collected fractions can be identified and/or characterized using any suitable methodology known in the art, such as, for example, Western blot analysis, enzymatic assays, immunofluorescence microscopy with fluorescently-labeled antibodies specific to organelle-specific markers, and microscopy, including, for example, electron microscopy, or any other known method. By these methods, for example, the organelle composition of a fraction can be assessed and characterized, for example, with respect to the relative amounts of different types of organelles present in the fraction. For example, by performing a Western blot analysis on a fraction and testing for the presence of organelle-specific markers, such as, for example, mitochondria, endoplasmic reticulum, plasma membrane, and Golgi, one can assess the relative amounts of each of these organelles comprising the fraction. Information on the preceding protocols can be found in commercially-available literature, such as, for example, Current Protocols in Cell Biology, John Wiley & Sons, Inc., 1999, Edited by Bonifacino et al. or Current Protocols in Molecular Biology, John Wiley & Sons, Inc., 1999, Edited by Juan S. Bonifacino.

Also, the integrity of the organelles can be determined by any suitable method in the art, such as, for example, quantitative enzymatic assays, Western blots to organelle-specific marker proteins and electron microscopy experiments. Transmission electron microscopy (TEM) can be used to identify the organelles and to qualitatively characterize the integrity of the organelles vis-à-vis their morphologies (e.g., size, shape, structural organization, and density), which can generally correlate with the function of the organelle. In other words, an organelle that has a higher degree of integrity generally would have a more intact function.

Organelle applications. The organelles obtained by the invention can be used in the field of proteomics, as well as other fields. Such other fields include, but are not limited to, genomics, neurochemistry, immunochemistry, biochemistry, histology, botany, plant biochemistry, physical anthropology, forensics and pathology, and combinations thereof. A skilled artisan would understand how organelles can be utilized in these disciplines. Further, the organelles obtained by the method of the invention can be used for the development of diagnostics, pharmaceuticals, chemicals and vaccines, useful in the fields of, for example, human, animal, livestock and pet care.

Protein Characterization and Quantitation. FIG. 2 relates to the characterization and the quantitation of the proteins present in the organelles. The separation, enrichment, and accumulation of subcellular organelles and other subcellular structures of interest according to the method of the invention can be thought of as a method for “pre-fractionating” a proteome of the biological sample since the proteome of the cell is divided up into the distinct types of subcellular organelles and structures. Thus, once the organelles are separated and purified, the proteome of the intact whole biological sample is effectively fractionated into sub-proteomic constituents. The process of the invention reduces the complexity of the proteome of the biological sample and facilitates the subsequent analysis of the protein constituents of the proteome.

Lyse organelles. As seen in FIG. 2, the accumulated organelles are lysed by any technique known in the art. Lysing is typically performed to disrupt the membrane of the organelle in a manner sufficient to release the contents of the organelle. The contents of the organelle include, for example, the proteome of the organelle.

Separate proteins and peptides. Once enrichment, accumulation, and lysis of the subcellular organelles are achieved, the protein constituents of each of the isolated organelles (e.g., the subcellular proteomes of each organelle) can be analyzed to facilitate the detection of a protein of interest, such as, a low-abundance protein. Different ways to analyze large populations of proteins and peptides, such as, the subcellular proteome of an organelle, are known in the art. One of ordinary skill in the art may select the most appropriate protein isolation and purification techniques without departing from the scope of this invention.

An example of a particular method is two-dimensional (2D) gel electrophoresis. Two-dimensional gel electrophoresis of a complex protein solution, such as a subcellular proteome, results in a pattern of separated, typically referred to in the art as resolved, polypeptides which can then be further investigated as to their identity. For example, Western blotting can be used to identify a specific type, class, or specific protein or fragment thereof through the probing with a specific antibody. Additionally, mass spectroscopy can be used to determine the identity of a resolved protein in a gel by comparison of molecular weight profiles of the resultant polypeptide fragments generated and detected by the mass spectrometer with information contained in a mass spectrometry database or whole-genome sequence or polypeptide database.

Detection and identification processes can be automated or semi-automated. Also, robotics or high-throughput instrumentation known to one of ordinary skill in the art can be used.

Other technologies useful for studying proteins include, for example, liquid chromatography, such as normal or reversed phase, using HPLC, FPLC and the like; size exclusion chromatography; immobilized metal chelate chromatography; affinity chromatography; any other chromatographic method; protein binding analysis; yeast two-hybrid analysis; three-dimensional structure studies; gel electrophoresis, such as, 1D and 2D; and most recently, protein/polypeptide microarrays, and bioinformatics.

Another technique within the scope of the invention to separate and proteins and peptides is multidimensional liquid chromatography (“MDLC”), also referred to as “MudPIT.” MudPIT is used as an alternative to two-dimensional gel electrophoresis to identify a different, and partially overlapping, set of proteins in a proteome. Instead of using an initial protein separation step like two-dimensional gel electrophoresis, the complete proteome of the biological sample, such as, a gradient fraction enriched for an organelle, is first digested with trypsin. The resulting complex mixture of peptides is resolved by MDLC using a combination of strong anion exchange (SAX) and reverse-phase (RP) columns, and the separated peptides are analyzed by tandem mass spectrometry (MS/MS). The information gained from MS/MS of the peptides is then used to predict protein identity.

Proteome analysis is typically performed by combining the high-resolution separation technique of 2D-GE with the highly sensitive identification capabilities of matrix-assisted laser desorption-ionization (“MALDI”) mass spectrometry. Several strategies based on this combination have been developed. Most recently, approaches based on ESI/MS/MS have emerged as complementary or alternative techniques for proteome analysis. Such approaches include global proteolytic digestion of a complex sample followed by partial separation of the proteolytic mixture using one or more iterative in-line chromatography steps, followed by analysis of the peptides using MS/MS, usually via an electrospray ionization interface. Independently from the strategy used to obtain the data, the experimentally obtained masses of digested peptides are introduced into database-searching programs in order to match the obtained values with those theoretically calculated for the tryptic peptides derived from all proteins within a given database.

Characterize and quantitate proteins and peptides. Referring again to FIG. 2, techniques to characterize and quantitate the proteins, such as low-abundance proteins, and peptides derived from the invention, include, for example, any known biochemical approach, enzyme assay, antibody immunoreaction, ligand analysis, protein/peptide mass spectrometry, substrate analysis, or combinations thereof. The type of experimentation used to validate the function of the protein typically depends on, and is guided by, the knowledge as to the predicted function of the protein.

In one embodiment, relative quantitation of protein levels can be obtained from 2D gels by comparing the intensity of protein/peptide spots in digitized versions of the gel image using computer software such as, for example, Phoretix 2D Evolution from Nonlinear Dynamics. Other methods that do not involve 2D gels can be used such as isotope-coded affinity tags (ICAT) (APPLIED BIOSYSTEMS, CA).

The ICAT method uses heavy and light versions of a reagent that react with proteins. In addition to this ‘isotope coding’, the reagent has a chemical group, iodoacetamide, that reacts with cysteine suflhydryl groups, and an affinity tag, biotin, to facilitate purification. An ICAT experiment typically involves reacting one proteome with the light version of the reagent and another proteome with the heavy version. The labelled proteomes are then combined together and analyzed using a suitable workflow instrument. For example, labelled peptides produced by trypsin are affinity purified from non-labelled peptides to reduce the complexity of the peptide mixture under analysis. The affinity-purified peptides are then separated and analyzed by MS.

Mass spectra of ICAT-labelled peptides typically contain pairs of ions that differ in mass equal to the difference in the masses of the heavy and light reagents. Because the peptides are being measured in the same mass spectrum, it is possible to obtain a relative quantitation of the peptides and therefore of the proteins in the two proteomes. ICAT is useful for quantitating proteomes or sub-proteomes that are not amenable to two-dimensional gel electrophoresis.

Identify proteins. Any identification or analytical technique available to a skilled artisan may be used to identify the proteins and peptides obtained by the invention. Technologies useful for identifying and studying proteins include, for example, mass spectrometry, co-immunoprecipitation, affinity chromatography, protein binding analysis, yeast two-hybrid analysis, three-dimensional structure studies, and most recently, protein/polypeptide microarrays and bioinformatics. Some of the more common identification techniques include 2D-GE combined with MALDI; ESI/MS-MS; and tandem mass spectrometry (MS-MS), usually via an electrospray ionization interface.

In one embodiment, the invention isolates and purifies proteins, in substantially pure form, particularly one or more low-abundance proteins, from the organelles accumulated by the method herein. For example, the low-abundance proteins can be removed from a polyacrylamide gel, such as the two-dimensional polyacrylamide gels of the invention, and purified therefrom using standard techniques. The low-abundance protein can also be purified using other art-recognized techniques, such as, for example, immunoprecipitation or immunoaffinity chromatography using antibodies specific to a particular low-abundance protein of interest. Further and as explained in greater detail herein, the gene coding for a low-abundance protein of interest can be cloned and expressed in a host organism, and isolated and purified using art-recognized techniques.

The low-abundance proteins of the invention are not meant to be limited to any particular class. Low-abundance proteins can be classified as such based on their relative quantity or copy numbers in the cell. For example, it is known that a typical cell has about 109 protein molecules, having at least 104 unique protein species and having a “dynamic range,” with respect to copy number, of orders of magnitude (i.e., from less than 102 copies to greater than 107). The “dynamic range” is the range that proteins in a cell show from the lowest number of copies to the highest number of copies. About 9,000 proteins in a cell are present in fewer than about 1,000 copies per cell and are known as the “low-abundance proteins.” The sum of the low abundance proteins in a cell generally constitutes less than about 3% of the cell's mass. For example, tyrosine kinases are present in the range of 30-40 copies per cell. Further, certain low abundance proteins may be present in the about picoMolar (pM) or 10⁻⁹ to the about femtoMolar (fM) or 10⁻¹² concentrations, for example at about 10⁻⁹, at about 10⁻¹², or at about below 10⁻⁹ concentrations.

Low-abundance proteins are generally difficult to detect using known protein analytical instrumentation and/or methods. For example, low-abundance proteins in the context of 2D gel electrophoresis can be difficult to detect as “spots” (an electrophoretically-separated polypeptide on a gel) based on low copy numbers and/or their overlap with more prevalent proteins. The present invention contemplates any low-abundance protein, even low-abundance proteins present in less than about 750, 500, 250 or 100 copies per cell, or even in about one copy per cell, known or unknown, intracellular or extracellular (such as proteins in the interstitial space, neurotransmitters and signaling proteins).

Protein Applications of Characterized Known and Unknown Proteins.

Referring again to FIG. 2, there are many ways to utilize the proteins obtained by the methods of the invention, such as the low-abundance proteins. For example, the proteins obtained by the method of the invention can be used for the development of diagnostics, pharmaceuticals, chemicals and vaccines, useful in the fields of, for example, human, animal, livestock and pet care.

One application of the invention provides for a method of analyzing proteomic changes among two sets of biological samples or as a function of time. The time relates to the point when the biological sample is taken, such as a biopsy. In this embodiment, at least two types of subcellular organelles are released from a biological sample, typically by an art-recognized homogenization or lysing procedure. The at least two types of subcellular organelles are then introduced to a density gradient within a continuous-flow ultracentrifuge. A centrifugal force is applied, preferably greater than or about 100,000×g, such that the at least two types of subcellular organelles migrate within the density gradient. In one embodiment, centrifugation is performed in a single run. After centrifugation, the at least two types of subcellular organelles are collected from the density gradient. The proteins from the at least two types of subcellular organelles are then isolated and purified to determine a proteomic profile of the at least two types of subcellular organelles at the first time. This process can also be performed with a single type of subcellular organelle.

A second biological sample is provided and the at least two different types of subcellular organelles are released therefrom. The at least two types of subcellular organelles are then introduced to a density gradient within a continuous-flow ultracentrifuge; and a centrifugal force is applied such that the at least two types of subcellular organelles migrate within the density gradient, preferably in a single run. After centrifugation, the at least two types of subcellular organelles are collected from the density gradient. The proteins from the at least two types of subcellular organelles are isolated and purified to determine a proteomic profile of the at least two types of subcellular organelles at a second time. This part of the process can also be carried out with one type of organelle. Finally, the proteomic profiles at the first and second times are analyzed by art-recognized techniques to detect changes in the proteomic profiles as a function of time. Such an invention finds applicability, for example, in analysis of disease states and when comparing proteomic profiles of individuals or different groups of individuals.

In another protein application embodiment, protein translocation events can be analyzed using the method of the present invention. More specifically, the translocation process relates to the intracellular and/or intercellular movement of a translocation protein and/or translocation proteins as a function of time. The relative amounts of the translocation protein in a first and second types of organelles of a first biological sample are first determined. The procedure includes, for example, homogenizing the first biological sample under conditions sufficient to release the first and second organelles into a homogenate, wherein the first and second organelles each comprise a subcellular proteome. The homogenate is then introduced into a density gradient within a continuous-flow ultracentrifuge. A centrifugal force is applied to the homogenate so that the first and second organelles migrate within the density gradient. The first and second organelles are removed from the density gradient, and the subcellular proteomes of the first and second organelles are subsequently solubilized. After solubilization, the translocation protein in the first and second organelles of the first biological sample is then detected and the level of the detected translocation protein is measured.

A second biological sample is similarly processed along the lines of the first biological sample. That is, the second biological sample is homogenized under conditions sufficient to release the first and second organelles into a homogenate, wherein the first and second organelles each comprise a subcellular proteome. The homogenate from the second biological sample is then introduced into a density gradient within a continuous-flow ultracentrifuge. A centrifugal force is applied to the homogenate so that the first and second organelles migrate within the density gradient. The first and second organelles are removed from the density gradient, and the subcellular proteomes of the first and second organelles are subsequently solubilized. After solubilization, the translocation protein in the first and second organelles of the second biological sample is then detected and the level of the detected translocation protein is measured.

After the translocation protein and/or translocation proteins of the first and second biological samples is detected and measured, the translocation process is analyzed. For example, the translocation process of the translocation protein as a function of time is determined by comparing the measured levels of the detected translocation protein in the first and second organelles for each of the biological samples at the first and second times.

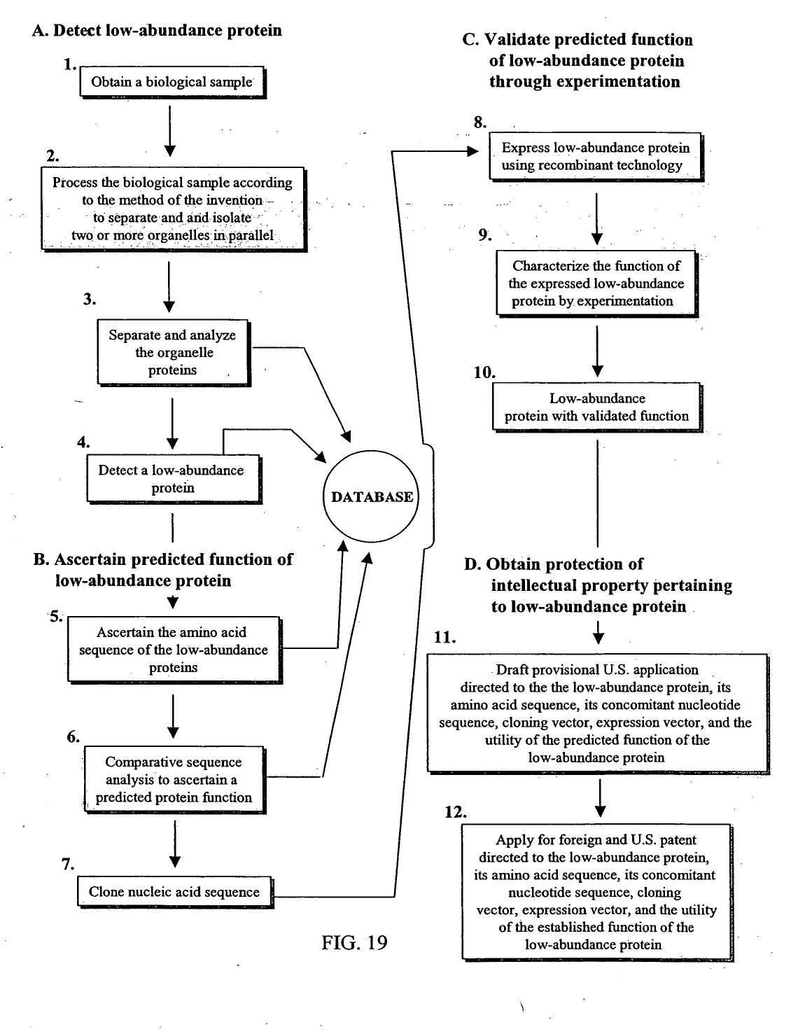

The invention further contemplates, as indicated at FIG. 19(A)(3-4), that the information pertaining to the analysis and separation of organelle proteins and the detection and/or identification of low-abundance proteins thereof can be provided to, transmitted to, or stored in a database to be accessed at a later point in time by the same or another user. The invention contemplates that any data generated or collected during the method of separating said proteins of a proteome or detecting a low-abundance protein can be transmitted or transferred to a third party. For example, image data relating to the pattern of resolved proteins on a two-dimensional gel or information pertaining to the different levels of expression of the resolved proteins of a gel can be transmitted electronically, for example by email, or over the internet or a network to a third party, to or from a database, to a laboratory, individual, or research group. The data can also be transferred (e.g., posting) electronically to a network, such as the World Wide Web or other global communications networks.

One of ordinary skill in the art will appreciate that the databases of the present invention can have many different forms and/or structures and can use any known protocols for electronic storage and retrieval of information. The invention further contemplates providing access to the database for commercial purposes. Access can be electronic access over a global communications network, such as the World Wide Web.

Once the low-abundance protein is identified by a detection method contemplated by the invention, such as by mass spectrometry, the complete amino acid sequence of the protein or protein fragment can be obtained from a whole-genome sequence database. The invention further contemplates the assessment of the putative function of a low-abundance protein of interest by comparative sequence analysis methods. Such methods are widely known in the art and pertain to computer software available locally on a desktop computer or workstation or available over a network, such as the World Wide Web, that employ algorithms for comparing an amino acid sequence of interest (e.g., the “query sequence”) with the amino acid sequences contained in a database to identify a polypeptide having a similar sequence whose function is already known. This general approach can be identified as “homology searching.” Homology searching does not positively identify a function for a query sequence but only establishes a likelihood that a particular sequence shares the same or similar function. Experimentation can be carried out to further confirm or validate the function of a protein of interest, such as, for example a low-abundance protein.

Thus, the low-abundance proteins of the invention can be assigned predicted function based on comparative sequence analyses (e.g., homology searching) to protein sequences in various databases, such as, for example GenBank, Swiss-Prot, and Protein Data Bank, etc. The term “percent identity” in the context of amino acid sequence refers to the residues in the two sequences which are the same when aligned for maximum correspondence. There are a number of different algorithms known in the art which can be used to measure sequence similarity or identity. For instance, polypeptide sequences can be compared using NCBI BLASTp and/or FASTA, a program in GCG version 6.1. FASTA provides alignments and percent sequence identity of the regions of the best overlap between the query and search sequences.

Alternatively, in the context of DNA or RNA, nucleotide sequence similarity or homology or identity can be determined using the “Align” program of Myers and Miller, (“Optimal Alignments in Linear Space”, CABIOS 4, 11-17, 1988) and available at NCBI. The terms “similarity” or “identity” or “homology”, for instance, with respect to a nucleotide sequence, is intended to indicate a quantitative measure of homology between two sequences. The percent sequence similarity can be calculated as (N_{ref}−N_{dif})*100/N_{ref}, wherein N_{dif} is the total number of non-identical residues in the two sequences when aligned and wherein N_{ref} is the number of residues in one of the sequences. Hence, the DNA sequence AGTCAGTC will have a sequence similarity of 75% with the sequence AATCAATC (N_{ref}=8; N_{dif}=2). Alternatively or additionally, “similarity” with respect to sequences refers to the number of positions with identical nucleotides divided by the number of nucleotides in the shorter of the two sequences wherein alignment of the two sequences can be determined in accordance with the Wilbur and Lipman algorithm (Wilbur and Lipman, 1983 PNAS USA 80:726), for instance, using a window size of 20 nucleotides, a word length of 4 nucleotides, and a gap penalty of 4, and computer-assisted analysis and interpretation of the sequence data including alignment can be conveniently performed using commercially available programs (e.g., Intelligenetics™ Suite, Intelligenetics Inc. CA). When RNA sequences are said to be similar, or have a degree of sequence identity with DNA sequences, thymidine (T) in the DNA sequence is considered equal to uracil (U) in the RNA sequence.

Once a putative or predicted function is ascertained for a given protein of interest, especially a low-abundance protein, a patent application can be drafted and filed with the with the appropriate national and/or international patent office. The application can be directed to, for example, the protein of interest whose function is predicted from homology searching. The claims can be directed to, for example, the amino acid sequence of the protein of interest, its utility based on its predicted function, or any cloning vector or expression vector carrying the DNA encoding said protein of interest.

The present invention, as seen in FIG. 19(C)(8), further contemplates validating the predicted function of a protein of interest, such as a low-abundance protein. Validation can be carried out using biochemical, immunological, physiochemical, protein structural, and genetic techniques, any of which are known to one of ordinary skill in the art. In one embodiment, as seen in FIG. 19(B)(7), the invention contemplates cloning the nucleic acid sequence encoding the protein of interest. Different strategies can be used to clone the gene, gene fragment, or nucleotide sequence encoding a protein of interest. For example, a degenerate nucleotide probe can be crafted based on the sequence of the protein of interest and used to screen a DNA or cDNA library for a plasmid or vector clone carrying the encoding piece of DNA. In another example, a nucleotide sequence encoding the DNA of interest can be amplified by PCR using primers that are based on the sequence of the protein of interest. Further, cloning steps can be subsequently carried out to obtain the transcriptional control regions of the encoding nucleotide sequence. The nucleotide sequences can be obtained not only from the original source of biological material, but also from another source of biological material sharing similar sequences.

Once the encoding nucleotide sequence is cloned, it can be further engineered into an expression vector, expressed in a host cell, isolated, and then further analyzed to assess and ascertain by experimentation the function of the protein of interest. Thus, the polypeptides of the present invention, such as the detected low-abundance proteins, are produced recombinantly and may be expressed in unicellular hosts. In order to obtain high expression levels of foreign DNA sequences in a host, the sequences can generally be operably linked to transcriptional and translational expression control sequences that are functional in the chosen host. Preferably, the expression control sequences, and the gene of interest, can be contained in an expression vector that further comprises a selection marker.

The DNA sequences encoding the polypeptides of this invention may or may not encode a signal sequence. If the expression host is eukaryotic, it generally is preferred that a signal sequence be encoded so that the mature glycoprotein is secreted from the eukaryotic host.

An amino terminal methionine may or may not be present on the expressed polypeptides in the compositions of this invention. If the terminal methionine is not cleaved by the expression host, it may, if desired, be chemically removed by standard techniques.

A wide variety of expression host/vector combinations may be employed in expressing the DNA sequences encoding the WNV polypeptides used in the pharmaceutical compositions and vaccines of this invention. Useful expression vectors for eukaryotic hosts, include, for example, vectors comprising expression control sequences from SV40, bovine papilloma virus, adenovirus, adeno-associated virus, cytomegalovirus and retroviruses including lentiviruses. Useful expression vectors for bacterial hosts include bacterial plasmids, such as those from E. coli, including pBluescript®, pGEX-2T, pUC vectors, col E1, pCR1, pBR322, pMB9 and their derivatives, pET-15, wider host range plasmids, such as RP4, phage DNAs, e.g., the numerous derivatives of phage lambda, e.g. λGT10 and λGT11, and other phages. Useful expression vectors for yeast cells include the 2μ plasmid and derivatives thereof. Useful vectors for insect cells include pVL 941.

In addition, any of a wide variety of expression control sequences, sequences that control the expression of a DNA sequence when operably linked to it, may be used in these vectors to express the polypeptides used in the compositions of this invention. Such useful expression control sequences include the expression control sequences associated with structural genes of the foregoing expression vectors. Examples of useful expression control sequences include, for example, the early and late promoters of SV40 or adenovirus, the lac system, the trp system, the TAC or TRC system, the T3 and T7 promoters, the major operator and promoter regions of phage lambda, the control regions of fd coat protein, the promoter for 3-phosphoglycerate kinase or other glycolytic enzymes, the promoters of acid phosphatase, e.g., Pho5, the promoters of the yeast-mating system and other constitutive and inducible promoter sequences known to control the expression of genes of prokaryotic or eukaryotic cells or their viruses, and various combinations thereof.

The term “host cell” refers to one or more cells into which a recombinant DNA molecule is introduced. Host cells of the invention include, but need not be limited to, bacterial, yeast, animal, insect and plant cells. Host cells can be unicellular, or can be grown in tissue culture as liquid cultures, monolayers or the like. Host cells may also be derived directly or indirectly from tissues.

A wide variety of unicellular host cells are useful in expressing the DNA sequences encoding the polypeptides used in the pharmaceutical compositions of this invention. These hosts may include well known eukaryotic and prokaryotic hosts, such as strains of E. coli, Pseudomonas, Bacillus, Streptomyces, fungi, yeast, insect cells such as Spodoptera frugiperda (SF9), animal cells such as CHO and mouse cells, African green monkey cells such as COS 1, COS 7, BSC 1, BSC 40, and BMT 10, and human cells, as well as plant cells.

A host cell is “transformed” by a nucleic acid when the nucleic acid is translocated into the cell from the extracellular environment. Any method of transferring a nucleic acid into the cell may be used; the term, unless otherwise indicated herein, does not imply any particular method of delivering a nucleic acid into a cell, nor that any particular cell type is the subject of transfer.

An “expression control sequence” is a nucleic acid sequence which regulates gene expression (i.e., transcription, RNA formation and/or translation). Expression control sequences may vary depending, for example, on the chosen host cell or organism (e.g., between prokaryotic and eukaryotic hosts), the type of transcription unit (e.g., which RNA polymerase must recognize the sequences), the cell type in which the gene is normally expressed (and, in turn, the biological factors normally present in that cell type).

A “promoter” is one such expression control sequence, and, as used herein, refers to an array of nucleic acid sequences which control, regulate and/or direct transcription of downstream (3′) nucleic acid sequences. As used herein, a promoter includes necessary nucleic acid sequences near the start site of transcription, such as, in the case of a polymerase II type promoter, a TATA element.

A “constitutive” promoter is a promoter which is active under most environmental and developmental conditions. An “inducible” promoter is a promoter which is inactive under at least one environmental or developmental condition and which can be switched “on” by altering that condition. A “tissue specific” promoter is active in certain tissue types of an organism, but not in other tissue types from the same organism. Similarly, a developmentally-regulated promoter is active during some but not all developmental stages of a host organism.

Expression control sequences also include distal enhancer or repressor elements which can be located as much as several thousand base pairs from the start site of transcription. They also include sequences required for RNA formation (e.g., capping, splicing, 3′ end formation and poly-adenylation, where appropriate); translation (e.g., ribosome binding site); and post-translational modifications (e.g., glycosylation, phosphorylation, methylation, prenylation, and the like).

The term “operably linked” refers to functional linkage between a nucleic acid expression control sequence (such as a promoter, or array of transcription factor binding sites) and a second nucleic acid sequence, wherein the expression control sequence directs transcription of the nucleic acid corresponding to the second sequence.

It should of course be understood that not all vectors and expression control sequences will function equally well to express the polypeptides mentioned herein. Neither will all hosts function equally well with the same expression system. However, one of skill in the art may make a selection among these vectors, expression control sequences and hosts without undue experimentation and without departing from the scope of this invention. For example, in selecting a vector, the host typically should be considered because the vector is replicated in it. The vector's copy number, the ability to control that copy number, the ability to control integration, if any, and the expression of any other proteins encoded by the vector, such as antibiotic or other selection markers, should also be considered.

In selecting an expression control sequence, a variety of factors should also be considered. These include, for example, the relative strength of the promoter sequence, its controllability, and its compatibility with the DNA sequence of the peptides described in this invention, in particular with regard to potential secondary structures. Unicellular hosts should be selected by consideration of their compatibility with the chosen vector, the toxicity of the product coded for by the DNA sequences encoding the glycoproteins used in a pharmaceutical composition, their secretion characteristics, their ability to fold the polypeptide correctly, their fermentation or culture requirements, and the ease of purification from them of the products coded for by the DNA sequences.

Within these parameters, one of skill in the art may select various vector/expression control sequence/host combinations that will express the DNA sequences encoding the products used in the pharmaceutical compositions on fermentation or in other large scale cultures.

The polypeptides described in this invention may be isolated from the fermentation or cell culture and purified using any of a variety of conventional methods described elsewhere herein. One of ordinary skill in the art may select the most appropriate isolation and purification techniques without departing from the scope of this invention. If the polypeptide is membrane bound or suspected of being a lipoprotein, it may be isolated using methods known in the art for such proteins, e.g., using any of a variety of suitable detergents.

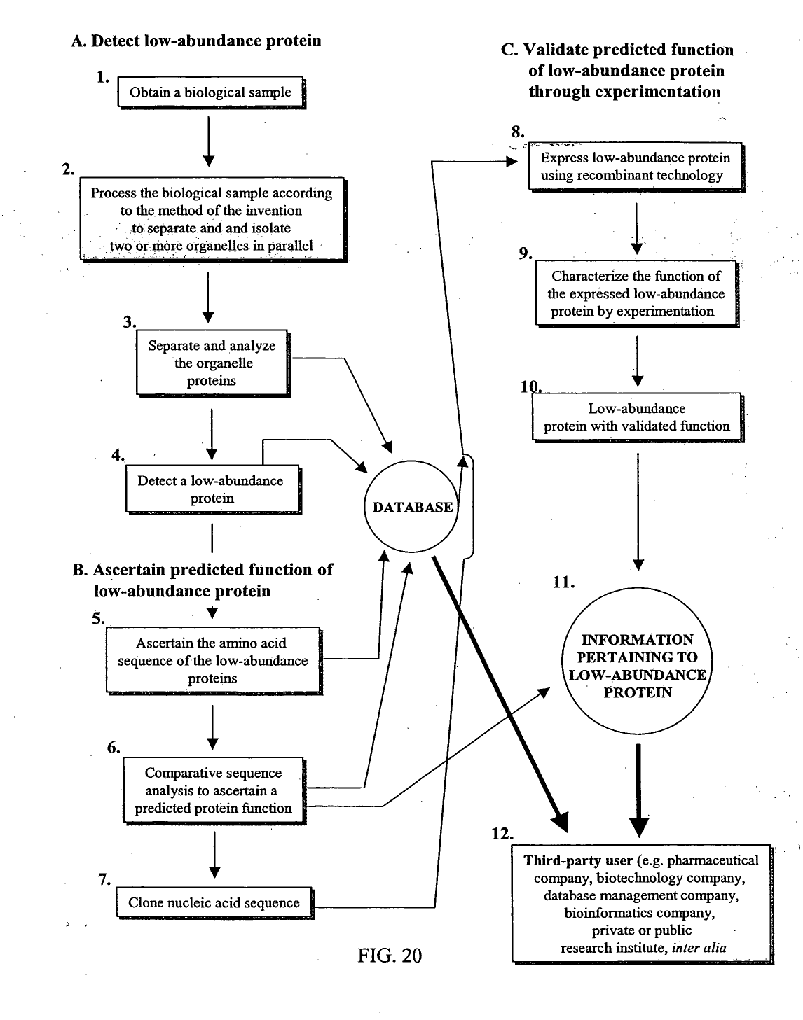

Once the function of the protein of interest is known or validated by experimentation, one may have in possession valuable intellectual property that can be protected by applying for a national or international patent directed to the protein of interest, such as, for example, a low-abundance protein of interest, its amino acid sequence, its function and/or biological activity, its concomitant nucleotide sequence, and the cloning vectors and expression vectors harboring the concomitant nucleotide sequence. In particular, the validated function of the protein of interest may indeed establish the utility requirement for obtaining a national or international patent. The information generated by the above steps, in particular the validated function of the protein of interest, such as a low-abundance protein, can also be distributed or transmitted to a third-party user, such as, for example, a pharmaceutical company, a biotechnology company, a database service, a bioinformatics company, or a private or public research institute. The invention contemplates, as indicated at FIG. 20(C)(11-12), that the information pertaining to the analysis and separation of organelle proteins and the detection and/or identification of low-abundance proteins thereof can be provided to, transmitted to, or stored in a database to be accessed at a later point in time by the same or another user.

The present invention further encompasses a method of transmitting data, for example disclosing the amino acid sequence of the identified protein or the nucleic acid molecule encoding said identified protein, information on the disease-related proteome profile of a specific organelle or organelles, information on the changes in proteome profile of a specific organelle or organelle upon application of a specific stimulus, such as, for example a drug, each transmitted by digital means, such as by facsimile, electronic mail, telephone, or a global communications network, such as the World Wide Web. For example, data can be transmitted via website posting, such as by subscription or select/secure access thereto and/or via electronic mail and/or via telephone, IR, radio, television or other frequency signal, and/or via electronic signals over cable and/or satellite transmission and/or via transmission of disks, compact discs (CDs), computers, hard drives, or other apparatus containing the information in electronic form, and/or transmission of written forms of the information, e.g., via facsimile transmission and the like. Thus, the invention comprehends a user performing according to the invention and transmitting information therefrom; for instance, to one or more parties who then further utilize some or all of the data or information, e.g., in the manufacture of products, such as therapeutics, assays and diagnostic tests and etc. This invention comprehends disks, CDs, computers, or other apparatus or means for storing or receiving or transmitting data or information containing information from methods and/or use of methods of the invention. Thus, the invention comprehends a method for transmitting information comprising performing a method as discussed herein and transmitting a result thereof.

Further still, the invention comprehends methods of doing business comprising performing or using some or all of the herein methods or organelles, proteins, compounds, compositions, or products derived therefrom, and communicating or transmitting or divulging a result or results thereof, advantageously in exchange for compensation, e.g., a fee. Advantageously, the communicating, transmitting or divulging of information is via electronic means, e.g., via internet or email, or by any other transmission means herein discussed. Thus, the invention comprehends methods of doing business involving the organelles, proteins, compositions, compounds, and products derived therefrom, and methods of the invention.

Thus, a first party, “client” can request information, e.g., via any of the herein mentioned transmission means—either previously prepared information or information specially ordered as to a particular amino acid sequence of a detected low-abundance proteins—of a second party, “vendor”, e.g., requesting information via electronic means such as via internet (for instance request typed into website) or via email. The vendor can transmit that information, e.g., via any of the transmission means herein mentioned, advantageously via electronic means, such as internet (for instance secure or subscription or select access website) or email. The information can come from performing some or all of a herein method or use of a herein method in response to the request, or from performing some or all of a herein method, and generating a library of information from performing some or all of a herein method or use of a herein algorithm. Meeting the request can then be by allowing the client access to the library or selecting data from the library that is responsive to the request.

Accordingly, the invention even further comprehends collections of information, e.g., in electronic form (such as forms of transmission discussed above), from performing or using a herein method or apparatus.

The present invention is additionally described by way of the following illustrative, non-limiting Examples that provide a better understanding of the present invention and of its many advantages.

### EXAMPLES

The following examples are set forth to illustrate various embodiments in accordance with the present invention. The following examples, however, are in no way meant to limit the present invention.

### Example 1

### Parallel Isolation, Purification and Enrichment of Mitochondria, Golgi, Endoplasmic Reticulum, and Plasma Membrane from Liver Tissue

Liver homogenization. Approximately 100 g of rat liver was harvested from male Wistar rats (150-200 g) that were fasted overnight prior to tissue isolation. Livers were homogenized in five volumes of homogenization buffer (0.5M sucrose, 20 mM HEPES-KOH, 5 mM MgCl₂ supplemented with an EDTA-free Protease Inhibitor Cocktail from Roche) utilizing a Waring blender (10 seconds low, 10 seconds high, and 10 seconds low). Following homogenization, a post-nuclear supernatant was obtained by centrifugation at 4-5000×g for 10 minutes. Following the first post-nuclear spin, the supernatant was decanted carefully. The post-nuclear supernatant was equilibrated to isotonic conditions by addition of an equal volume of dilution buffer (20 mM HEPES-KOH, pH 7.2, 5 mM MgCl₂).

Continuous-flow ultracentrifugation. For continuous flow centrifugation, sucrose gradient was established in the PK3-800 rotor after which the rat liver homogenate was fed into the machine. A flow rate of approximately 20 ml/min was used and the PKII was operated initially at 20,000 rpm for the first pass and then at maximum speed, 40,000 rpm for the second pass. Samples from the effluent were captured and later analyzed to determine the capture efficiency for the target organelles. Organelles were given additional time after all the homogenate had been fed to the system to reach their banding densities. The rotor was brought to a controlled stop and the rotor contents were unloaded from the bottom in 25 ml aliquots.

In another experiment, the PK3-800 rotor was filled with buffer (250 mM sucrose, 20 mM HEPES-KOH, pH 7.2, 5 mM MgCl₂) and air was removed from the system by spinning the rotor at 10,000 rpm. Flow through the lines was increased to 300 ml/min and flow through the rotor was reversed several times until air had been cleared from the system. The rotor was brought to a stop and the gradient material (i.e. sucrose) was pumped to fill half the rotor volume (approximately 400 ml).

The rotor was accelerated under automatic operation to the maximum speed (35,000 rpm or 40,000 rpm). Flow of buffer was allowed to continue at approximately 40 ml/min during gradient formation. Once the homogenate pool was ready for processing, the rotor speed was reduced to 20,000 rpm. The homogenate was fed at 20 ml/min and the effluent material was collected and a sample was retained for later analysis.

The feed was switched back to buffer and the rotor speed was increased to 35,000 or 40,000. The effluent collected from the 20,000 rpm feed was then re-fed to the PKII at 20 ml/min. The effluent was collected and a sample was retained for later analysis.

The feed was switched back to buffer and the lines were cleared. The flow was then shut off and the material in the rotor was allowed to band for 45 minutes or 2 hours. The rotor was brought to a controlled stop and fractions were immediately collected. Aliquots were prepared and stored at −80° C. Working aliquots were maintained at 4° C. for immediate analysis.

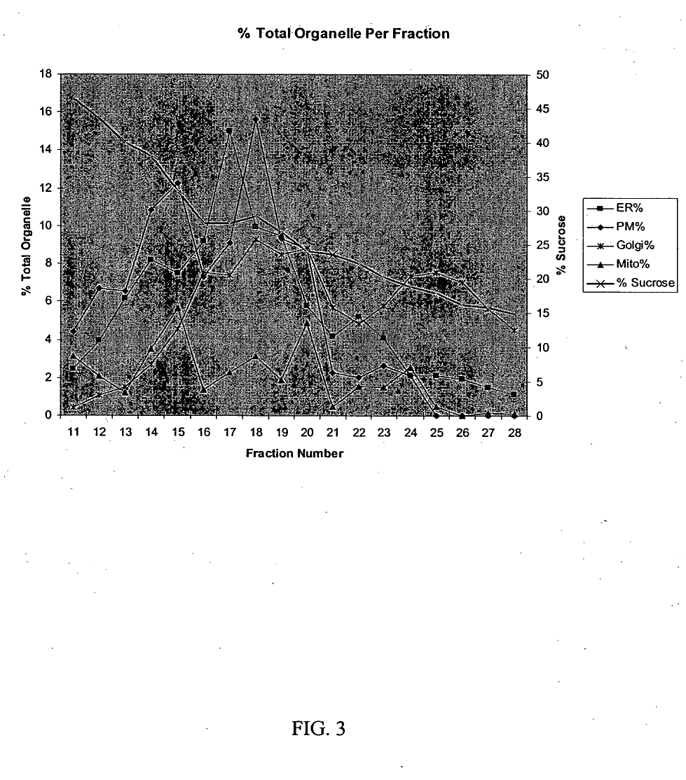

Identification of organelles following centrifugation. After centrifugation, the integrity separation, and enrichment of the isolated organelles were determined by Western blotting, enzymatic assays and electron microscopy. The results of these experiments are summarized in FIGS. 3-6.

FIG. 3 shows the relative distribution of mitochondria, Golgi, endoplasmic reticulum, and plasma membrane and sub-types thereof in different fractions of sucrose gradient following separation and accumulation of these organelles as described above. The X axis of the figure corresponds to each of the fractions measured for organelle content. The Y axis indicates percentage of these four organelles and sub-types thereof, detected at the corresponding sucrose gradient fractions, relative to the population within the range of gradient examined for each of these organelles and sub-types thereof. The Y2 axis shows the percentage of sucrose for each corresponding fraction of the gradient. FIG. 3 indicates the distribution of each of these organelles and sub-types thereof in distinct and well-defined locations in the gradient.

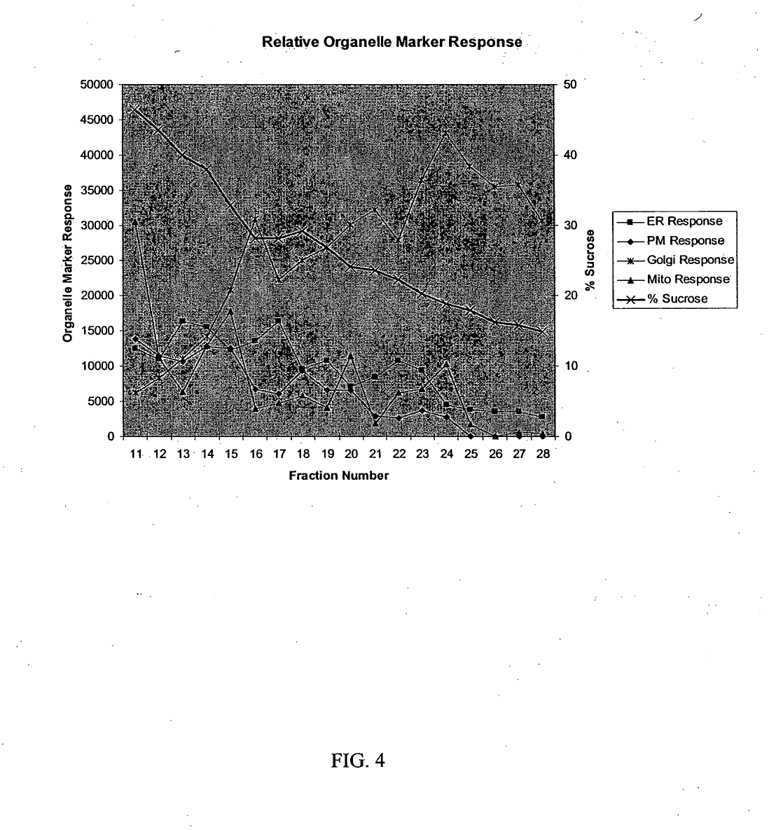

FIG. 4 shows the relative enrichment of mitochondria, Golgi, endoplasmic reticulum, and plasma membrane and sub-types thereof in different fractions of sucrose gradient following separation and accumulation of these organelles as described above. The X axis of the figure corresponds to each of the fractions measured for relative organelle marker response. The Y axis indicates relative organelle marker response (pixels) of these four organelles and sub-types thereof, detected at the corresponding sucrose gradient fractions, relative to the population within the range of gradient examined for each of these organelles and sub-types thereof. The Y2 axis shows the percentage of sucrose for each corresponding fraction of the gradient. FIG. 4 shows the relative enrichment of each of these organelles and sub-types thereof in distinct and well-defined locations in the gradient using the method of the invention.

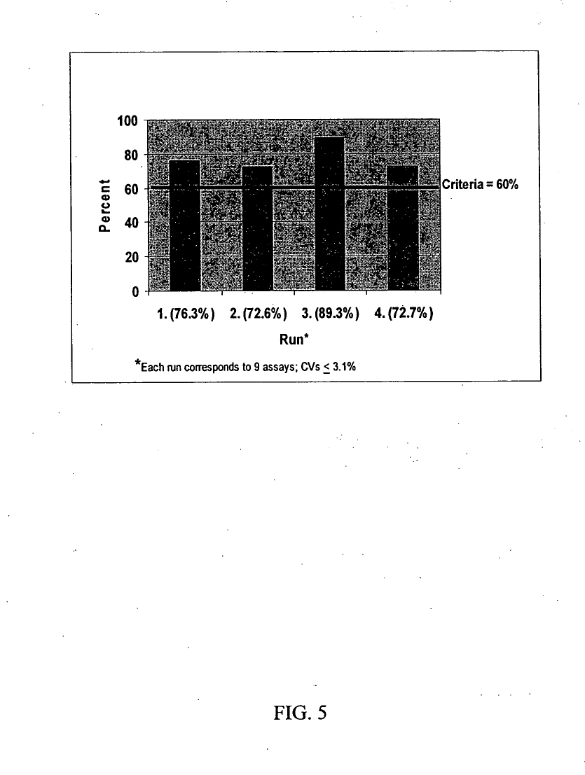

FIG. 5 shows the high integrity level of the isolated organelles-above values typically seen in the art. The data shows that endoplasmic reticulum, mitochondria, Golgi apparatus, and plasma membrane, and sub-types thereof, attained integrity levels of 76.3% (endoplasmic reticulum), 72.6% (mitochondria), 89.3% (Golgi), and 72.7% (plasma membrane), respectively. Integrity was determined by comparing the level of an organelle-specific enzymatic activity between the soluble and insoluble phases of the organelle preparations of the invention. The enzymatic activity of the insoluble fraction (organelles) was compared relative to the total enzymatic activity determined for both the soluble (supernatant) and the insoluble fractions.

Integrity for endoplasmic reticulum was determined collectively by quantitative enzymatic assays, Western blots to organelle-specific marker proteins and electron microscopy experiments. In particular, pellets and supernatants were assayed in parallel for organelle-specific marker enzymes and proteins. Detection of the marker in the pellet at a level>60% is indicative of intactness/integrity. In contrast, detection of the marker protein in the supernatant is an indication that the outer periphery of the organelle is compromised. For Western blots, the same antibodies were used to detect organelle-specific markers as used for the method of determining purity. Namely, anti-BiP/GRP78 antibody (BD BIOSCIENCES) was used to detect endoplasmic reticulum.

Transmission electron microscopy (TEM) was also employed to qualitatively characterize the integrity of the organelles vis-à-vis their morphologies (size, shape, structural organization), which correlates with function. To determine organelle intactness by electron microscopy, samples from the fractionation procedure were collected immediately following the centrifuge run to avoid potential damage from further manipulation. Samples were selected based on the expected density range as reported in the literature for the respective organelles. Selected fractions were pelleted and fixed in a solution of 4% formaldehyde, 1% glutaraldehyde in 0.1 M phosphate buffer, pH 7.4 and stored at 4° C. until needed for preparation. Samples were embedded, sectioned, stained with uranyl acetate and lead citrate and observed using a Zeiss electron microscope.

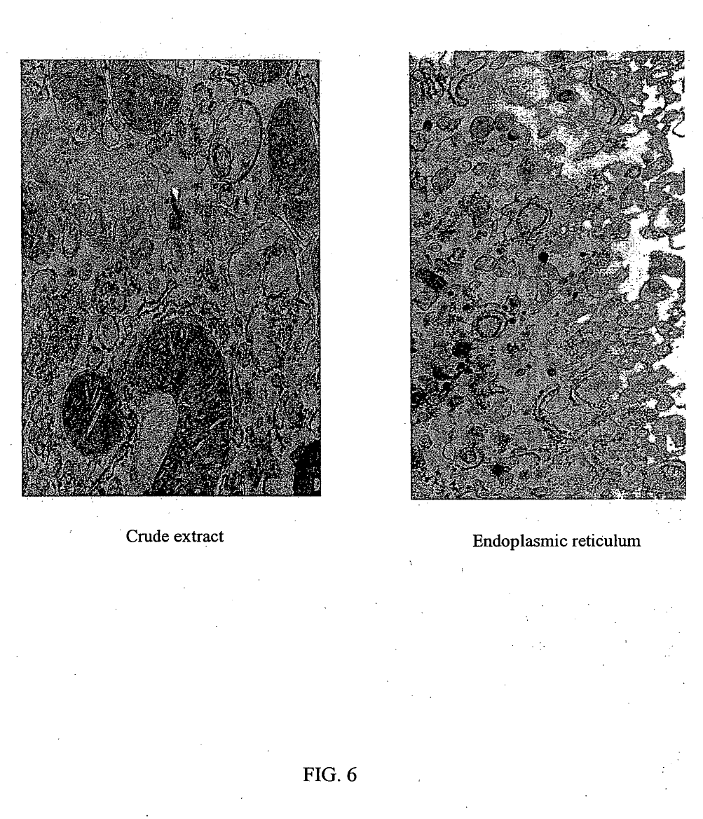

FIG. 6 compares the TEM of a crude extract sample and an endoplasmic reticulum fraction following the fractionation method described above. As compared to the TEM of the crude extract, it can be seen that the subcellular structures present in the ER fraction are almost exclusively endoplasmic reticulum. This observation qualitatively illustrates the high degree of purity and enrichment obtained by the fractionation method of the invention. Further upon inspection, the ultrastructure of the organelles in both the crude and the ER samples are seemingly well-intact, consistent with the high level of integrity as determined quantitatively (FIG. 2).

### Example 2

### Parallel Isolation, Purification and Enrichment of Mitochondria, Endoplasmic Reticulum, Golgi, and Plasma Membrane for Proteomic Analysis from HeLa Cells

HeLa cells were cultured in Joklik modified SMEM (Sigma, #61100-103) that was supplemented with sodium bicarbonate (Amresco, #0865), 10% fetal bovine serum (Paragon BioServices, #30101121) and 50 ug/ml gentamycin (Amresco, #0304). Cells were scaled up from roller bottles into a 40 L fully-controlled bioreactor for inoculation into a 200 L bioreactor. The reactor was seeded at a density of 1.0×10⁵ cells/ml.

Three days later, cells were harvested from the reactor and concentrated by tangential flow filtration to a volume of 8 liters, which were subsequently centrifuged at 2000 rpm for 12 minutes. The cell pellet was washed and resuspended in DPBS (Invitrogen, #14190-136) and then centrifuged again at 2000 rpm for 12 minutes. The supernatant was removed and the cell pellet was stored at −80° C. in 30 g aliquots.

HeLa cell pellets were removed from −80° C. storage. The pellets were thawed, pooled and homogenized in five volumes of homogenization buffer (0.25M sucrose, 20 mM HEPES-KOH, pH 7.2, 5 mM MgCl₂, EDTA-free Protease Inhibitor Cocktail from Roche) utilizing a Dounce homogenizer (25 strokes). Following homogenization, a post-nuclear supernatant was obtained by centrifugation at 4000×g for 10 minutes. Following the first post-nuclear spin, the supernatant was decanted. The nuclear pellet was then reprocessed to generate a second post-nuclear supernatant utilizing a blender (10 sec. Low, 10 sec. High, and 10 sec. low) (in 5 volumes of buffer) and same centrifugation parameters used above. The second post-nuclear supernatant was decanted and combined with the first post-nuclear supernatant. The resultant pooled homogenate was used in the PKII for fractionation of the organelles. Aliquots of the crude homogenate were stored at −80° C. for later analysis.

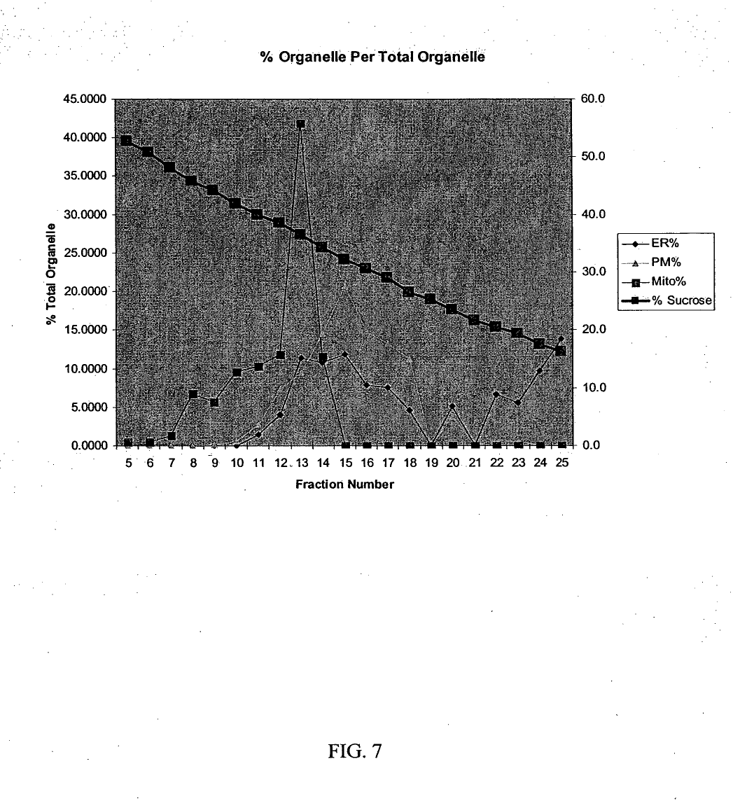

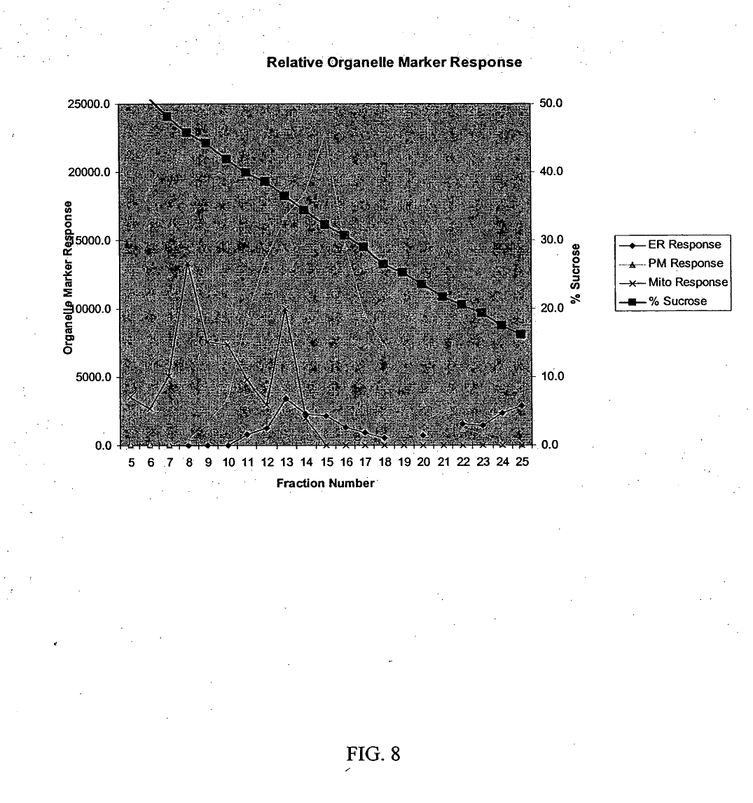

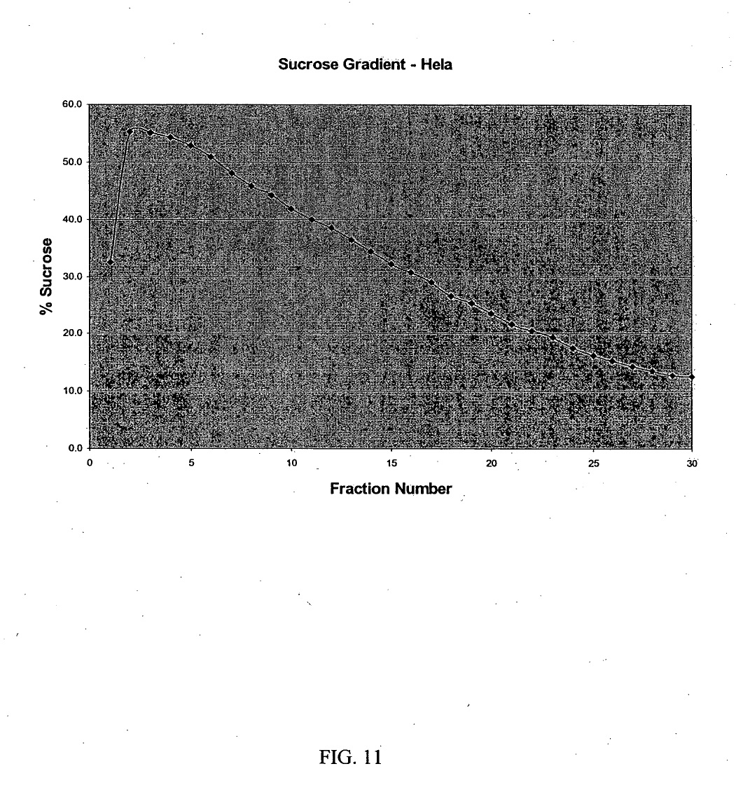

To gauge the overall organelle content of a given fraction and to compare between fractions, the refractive index for each sample was determined using an Abbe refractometer. Percent (%) sucrose may be calculated from refractive index measurements. Alternatively, it may be obtained through conversion tables of refractive index to percent sucrose in reference texts such as the CRC Handbook of Chemistry and Physics (Ed. R. Weast, CRC Press Inc., 58th Edition). FIG. 11 depicts the percentage sucrose content for collected post-centrifugation fractions of homogenized and centriguged HeLa cells. This figure relates directly to the fractions illustrated in FIGS. 7 and 8 (described below) and this example.

In order to test for intactness and enrichment of the isolated organelles, the isolated fractions were subjected to a combination of electron microscopy analysis, Western blotting and succinate dehydrogenase enzymatic assay.

To test for intactness of organelle isolation, samples from the fractionation were collected immediately following the run to avoid potential damage from further manipulation. Samples were selected based on the expected density range as reported in the literature for the respective organelles. Selected fractions were pelleted and fixed in a solution of 4% formaldehyde, 1% glutaraldehyde in 0.1 M phosphate buffer, pH 7.4 and stored at 4° C. until needed for preparation. Samples were embedded, sectioned, stained with uranyl acetate and lead citrate and observed using a Zeiss electron microscope.

In order to standardize Western blotting and enzymatic assays, the protein concentrations of the organelle-containing fractions were determined by Bradford assay (BIO-RAD, #500-0006). Samples were incubated with Coomassie reagent for five minutes at room temperature, and the absorbance was measured (595 nm). A standard curve was generated using BSA (Pierce, #23210).

After determining the protein concentration of the organelle-containing fractions, the fractions were ascertained as to their organelle composition by screening each of the fractions by Western (immunoblot) blot using antibodies to known organelle-specific markers. Equal quantities of protein extracts from the organelle-containing fractions were resolved by polyacrylamide gel electrophoresis followed by the detection of the organelle-specific markers using appropriate antibodies. For example, anti-Tom20 antibody (BD BIOSCIENCES) was used to detect mitochondria, anti-GM130/P115 antibody (BD BIOSCIENCES) was used to detect Golgi, anti-BiP/GRP78 antibody (BD BIOSCIENCES) was used to detect endoplasmic reticulum, and anti-NaKATPase antibody (UNIV. OF IOWA) was used to detect plasma membrane.

To carry out polyacrylamide gel electrophoresis, samples were mixed with 4×NuPAGE SDS sample buffer (INVITROGEN, #NP0007) and 50 mM DTT prior to being loaded into either 1.0 mm×10 well or 1.5 mm×15 well, 4-12% Bis-Tris gradient minigels (INVITROGEN, #NP0335 or NP0323). Samples were electrophoresed for approximately 40 minutes at 150 V using MES SDS running buffer. For total protein analysis, gels were stained for 0.5 hours in Coomassie blue in 40% methanol, 10% acetic acid and subsequently destained in a 10% methanol, 10% acetic acid solution. Immunoreactive bands were detected using ECL detection (#RPN2108, ECL Western Blotting Analysis System, AMERSHAM, INC.) and quantified using Kodak Digital Science 1D Image Analysis software (KODAK).

In addition to Western blotting, enzymatic essays, for example, the succinate dehydrogenase enzymatic assay, were carried out to further assess the integrity of the isolated organelles of the recovered fractions. For these experiments, each 50 ul sample of organelle fraction was incubated with 0.3 ml of a 0.01M solution of sodium succinate (Sigma, #S2378) in 0.05 M phosphate buffer, pH 7.5. Following incubation at 37° C. for 10 minutes, 0.1 ml of a 2.5 mg/ml solution of p-Iodonitrotetrazolium violet (INT) (Sigma, #18377) in 0.05 M phosphate buffer, pH 7.5 was added. The tubes were incubated at 37° C. for 10 minutes. The reaction was stopped with the addition of 1.0 ml of ethyl acetate: ethanol: trichloroacetic acid in a ratio of 5:5:1 (v,v,w). The tubes were centrifuged at 15,000 rpm for 1 minute before measuring the absorbance at 490 nm. The results of these experiments are summarized in FIGS. 7-11.

FIG. 7 shows the relative distribution of mitochondria, endoplasmic reticulum, and plasma membrane and sub-types thereof in different fractions of sucrose gradient following separation and accumulation of these organelles as described above. The X axis of the figure corresponds to each of the fractions measured for organelle content. The Y axis indicates percentage of these three organelles and sub-types thereof, detected at the corresponding sucrose gradient fractions, relative to the population within the range of gradient examined for each of these organelles and sub-types thereof. The Y2 axis shows the percentage of sucrose for each corresponding fraction of the gradient. FIG. 7 indicates the distribution of each of these organelles and sub-types thereof in distinct and well-defined locations in the gradient.

FIG. 8 shows the relative enrichment of mitochondria, endoplasmic reticulum, and plasma membrane and sub-types thereof in different fractions of sucrose gradient following separation and accumulation of these organelles as described above. The X axis of the figure corresponds to each of the fractions measured for relative organelle marker response. The Y axis indicates relative organelle marker response (pixels) of these three organelles and sub-types thereof, detected at the corresponding sucrose gradient fractions, relative to the population within the range of gradient examined for each of these organelles and sub-types thereof. The Y2 axis shows the percentage of sucrose for each corresponding fraction of the gradient. FIG. 8 shows the relative enrichment of each of these organelles and sub-types thereof in distinct and well-defined locations in the gradient using the method of the invention.

### Example 3

### Comparative Enrichment Studies Using HeLa Cells

Referring to the experimental conditions presented in Example 2 above, comparative enrichment was studied in accordance with the following data.

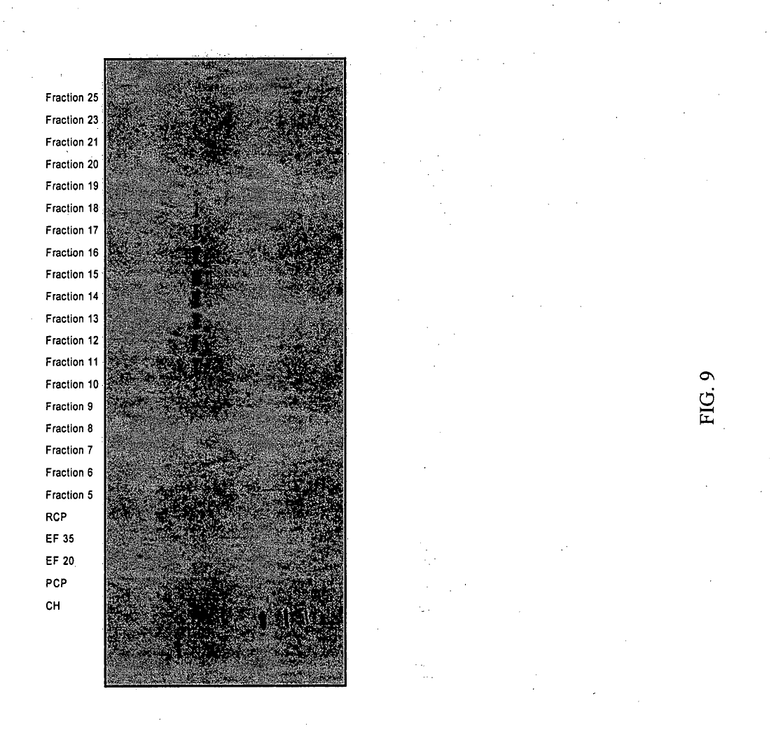

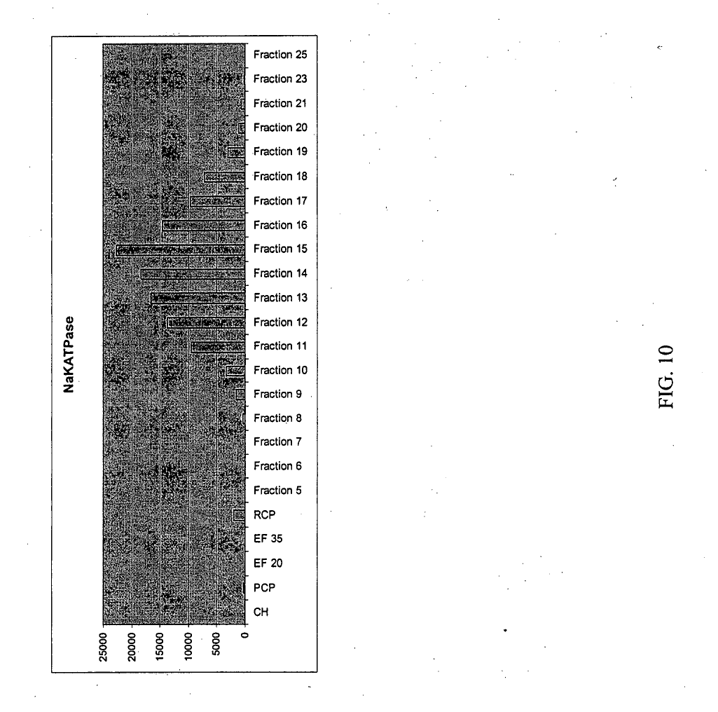

FIGS. 9 and 10 illustrate the comparative levels of enrichment achieved by the method of the invention. Enrichment can be determined qualitatively either using Western blots or enzymatic assays of organelle-specific markers and/or enzymes contrasting the signal/activity from the particular fraction of interest to the signal/activity present in another fraction or in the original crude extract of the biological sample prior to fractionation. Relative enrichment can be determined based upon the accumulation of the marker protein in the organelle fraction relative to another organelle fraction. Further, enrichment can be measured by the activity of an organelle-specific marker enzyme for an organelle of interest relative to the activity of the same marker enzyme in another fraction or in the crude homogenate. FIG. 9 shows a Western blot of NaKATPase as detected by antiNaKATPase antibody from each of the fractions of the biological sample.

FIG. 10 shows the measured level of NaKATPase from each of the fractions of the sample. A comparison of FIGS. 9 and 10 indicate that fractions 14 and 15 have the highest relative level of NaKATPase. Since NaKATPase is the organelle-specific marker for plasma membrane, the data suggests that fractions 14 and 15 have the greatest concentration of plasma membrane.

To determine organelle integrity and enrichment by Western blotting and/or enzymatic assays, firstly, protein content was determined by a Bradford based assay (Bio-Rad, #500-0006). Samples were incubated with Coomassie reagent for five minutes at room temperature, and the absorbance was measured (595 nm). A standard curve was generated using BSA (Pierce, #23210)

Prior to western blotting, samples were mixed with 4×NuPAGE SDS sample buffer (INVITROGEN, #NP0007) and 50 mM DTT prior to being loaded into either 1.0 mm×10 well or 1.5 mm into x 15 well, 4-12% Bis-Tris gradient minigels (INVITROGEN, #NP0335 or NP0323). Samples were electrophoresed for approximately 40 minutes at 150 V using MES SDS running buffer. For total protein analysis gels were stained for 0.5 hours in Coomassie blue in 40% methanol, 10% acetic acid and subsequently destained in a 10% methanol, 10% acetic acid solution.

To carry out polyacrylamide gel electrophoresis, samples were mixed with 4×NuPAGE SDS sample buffer (INVITROGEN, #NP0007) and 50 mM DTT prior to being loaded into either 1.0 mm×10 well or 1.5 mm×15 well, 4-12% Bis-Tris gradient minigels (INVITROGEN, #NP0335 or NP0323). Samples were electrophoresed for approximately 40 minutes at 150 V using MES SDS running buffer. For total protein analysis, gels were stained for 0.5 hours in Coomassie blue in 40% methanol, 10% acetic acid and subsequently destained in a 10% methanol, 10% acetic acid solution. Immunoreactive bands were detected using ECL detection#RPN2108, ECL Western Blotting Analysis System, AMERSHAM, INC.) and quantified using Kodak Digital Science 1D Image Analysis software (KODAK). For the succinate dehydrogenase enzymatic assay, each 50 ul of the homogenate was incubated with 0.3 ml of a 0.01M solution of sodium succinate (Sigma. #S2378) in 0.05 M phosphate buffer, pH 7.5. Following incubation at 37° C. for 10 minutes. 0.1 ml of a 2.5 mg/ml solution of p-Iodonitrotetrazolium violet (INT) (Sigma, #18377) in 0.05 M phosphate buffer, pH 7.5 was added. The tubes were incubated at 37° C. for 10 minutes. The reaction was stopped with the addition of 1.0 ml of ethyl acetate:ethanol:trichloroacetic acid n a ratio of 5:5:1 (v,v,w). The tubes were centrifuged at 15,000 rpm for 1 minute before measuring the absorbance at 490 nm.

### Example 4

### Analysis of Subcellular Proteomes of Organelle Fractions by 2D Gel Electrophoresis and Mass Spectrometry Reveals Novel Proteins

The subcellular proteomes of the organelles of the fractions provided by Examples 1 and 2 were further analyzed by 2D gel electrophoresis and mass spectrometry. To analyze the subcellular organelle proteomes, proteins were separated by two-dimensional gel electrophoresis (“2D-GE”). It will be appreciated by one of ordinary skill in the art that 2D-GE is a powerful approach for separating complex mixtures of proteins. All proteins in an electric field migrate to a defined distance that is dependent upon their conformation, molecular size and electric charge. 2D-GE uses the latter two of these parameters to allow high-resolution separation of proteins. In the first dimension, isoelectric focusing is used to separate proteins based on their isoelectric point. In the second dimension, SDS polyacrylamide gel electrophoresis is used to fractionate proteins according to their molecular weights. The result is an array of proteins spots that are assigned X and Y coordinates.

Here, separation of organelle protein extracts subsequent to organelle lysis was performed by 2D-GE and detection was with either Coomassie blue, silver staining or Sypro Ruby™ (MOLECULAR PROBES). Organelle protein extracts were compared relative to unfractionated crude extracts fractionated on 2D-GE gels, all stained with Coomassie blue, silver, or Sypro Ruby™. Digital images of the 2D gels were generated and annotated using Z3™ software (COMPUGEN) or Progenesis™ software (NON LINEAR). Resultant images were superimposed to identify common and new spots, especially low-abundance proteins.

The isoelectric focusing step was performed using Bio-Rad 7 cm IPG strips over a full pH range (3-10). SDSPAGE was then performed using pre-cast NuPAGE 4-12% Bis-Tris ZOOM gels with a molecular weight standard. Samples were run in duplicate with one gel stained with Coomassie and a second gel stained with Silver. Organelle fractions and crude homogenates were subjected to mass spectrometry using a 2-D gel intermediary and analyzed by MALDI.

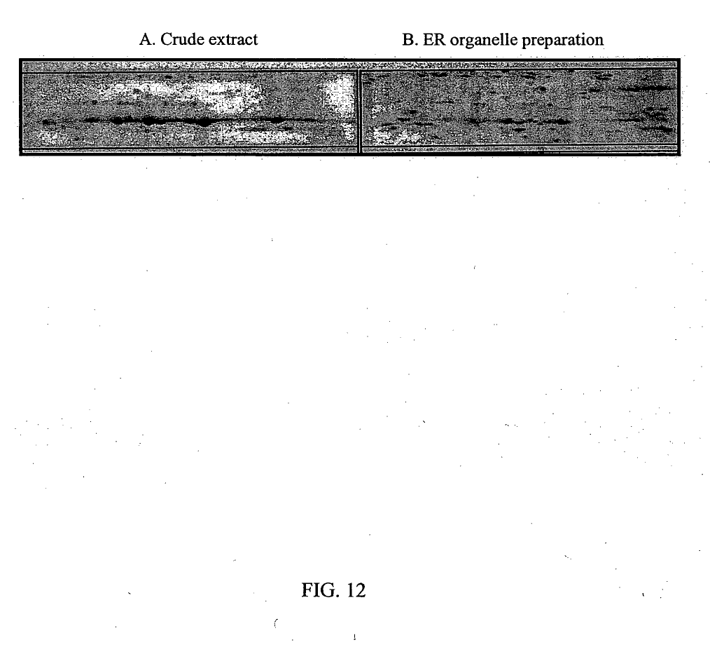

FIG. 12 compares the protein spot patterns of a crude extract (A) of rat liver tissue and the endoplasmic reticulum fraction (B) of Example 1. Compared to the crude extract gel, the endoplasmic reticulum gel shows significantly greater proteome content, i.e. a greater number of visible and/or detectable protein or polypeptide spots.

In addition to the 2D gel results shown in FIG. 12 for the analysis of the endoplasmic reticulum fraction, similar 2D gel analysis was carried out for fractions containing mitochondria, plasma membrane, and Golgi apparatus (data not shown). The resulting 2D gels were further analyzed by mass spectrometry. A number of the spots of the gel of FIG. 12(A), as well as the gels for the mitochondria, plasma membrane, and Golgi apparatus fractions, were analyzed by mass spectrometry. The resulting peptide profile determined for each spot was compared against known peptide profile databases such as, for example, GENBANK and SWISS-PROT, to determine the identity, if any, of the protein spot.

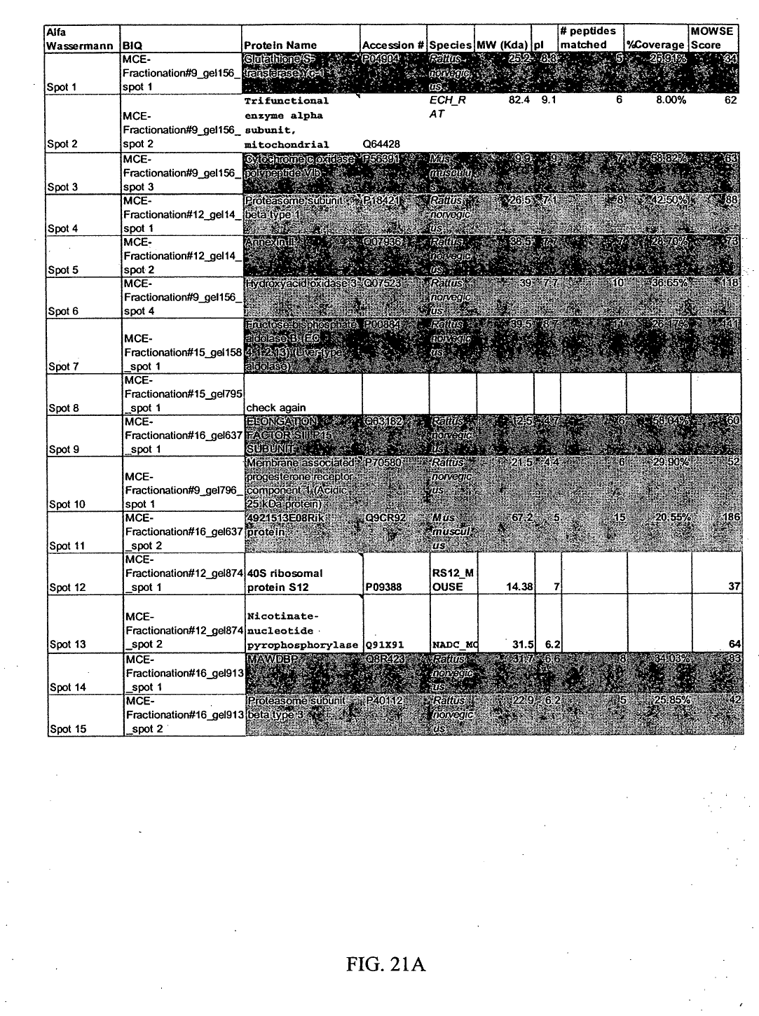

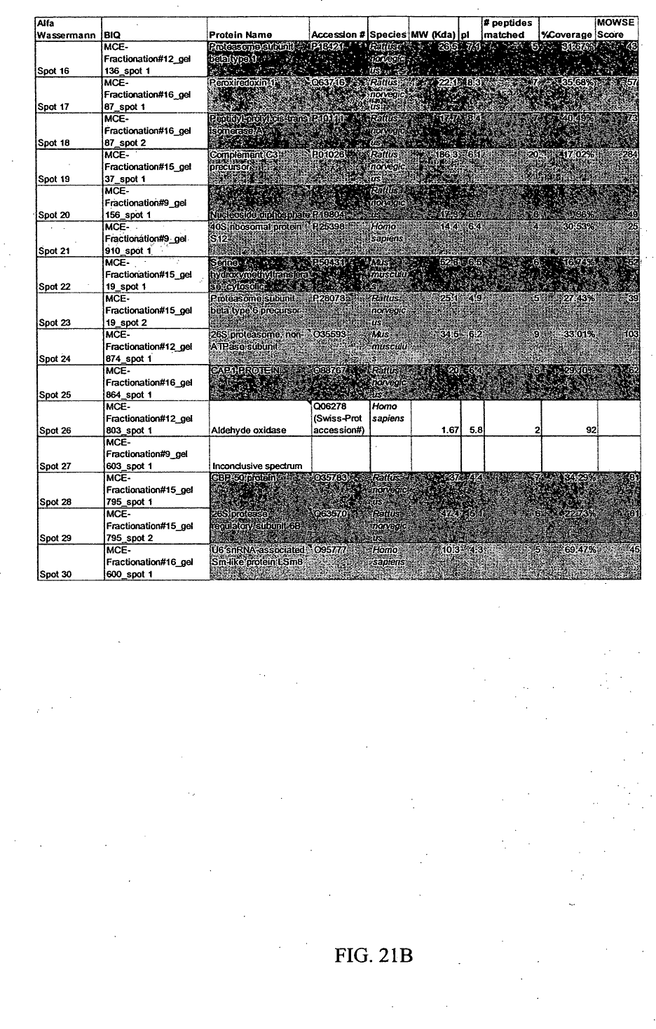

The results showed that many proteins could be detected in the mitochondria, endoplasmic reticulum, Golgi apparatus, and plasma membrane fractions that were not present or detectable in the 2D gels of the crude extract. Further, the proteins found on the 2D gels of each of the organelle fractions were identified as having a broad range of molecular weight, namely a high molecular weight of about 80-125 kD to a low molecular weight of about less than 20 kD. Thus, the results suggest that the method of the invention is not biased or limited as to any particular molecular weight. A number of protein spots that were not observable on the 2D gel of the starting biological material and were of low-intensity on the 2D gel of the organelle-containing fraction were analyzed by mass spectrometry. Samples from both HeLa cells (data not shown) and rat liver tissue were examined. Of the protein spots examined for the rat liver tissue, about 50% were found to match proteins deposited in SWISS-PROT. Also, the identity of about 50% of the protein spots were ascertained through sequence analysis and comparison to known sequences in GENBANK. Where necessary, homology searching was carried out on non-rat databases. Results from the rat liver tissue are shown in FIGS. 21A and 21B.

Based on the identity of the proteins having matches to known proteins in existing databases, the method of the invention detected a variety of proteins, including metabolic enzymes, proteosome components, translational factors, receptors, immunological components (complement), and ribosomal proteins.

### Example 5

### Analysis of Subcellular Proteomes of Golgi and Plasma Membrane Fractions by 2D Gel Electorphoresis and Mass Spectrometry Demonstrates Detection of Post-Translational or Other Variants of Peptidyl-Prolyl Cis-Trans Isomerase (Cyclo-Sporin A-Binding Protein)

Separate fractions containing Golgi apparatus and plasma membrane isolated from HeLa cells according to Example 2, as well as HeLa crude extracts, were analyzed by 2D gel electrophoresis and mass spectrometry. The fractions were lysed to release organelle-contained proteins. A Bradford assay (Bio-Rad, #500-0006) was used to determine the concentration of the protein in Golgi sample, the plasma membrane sample, and the crude extract sample. Next, as outlined above, 2D gel electrophoresis was carried out on equal quantities of protein from each of the samples. As described previously, the 2D gel was stained appropriately to visualize the protein spots and then imaged by Progenesis™ software (NON LINEAR).

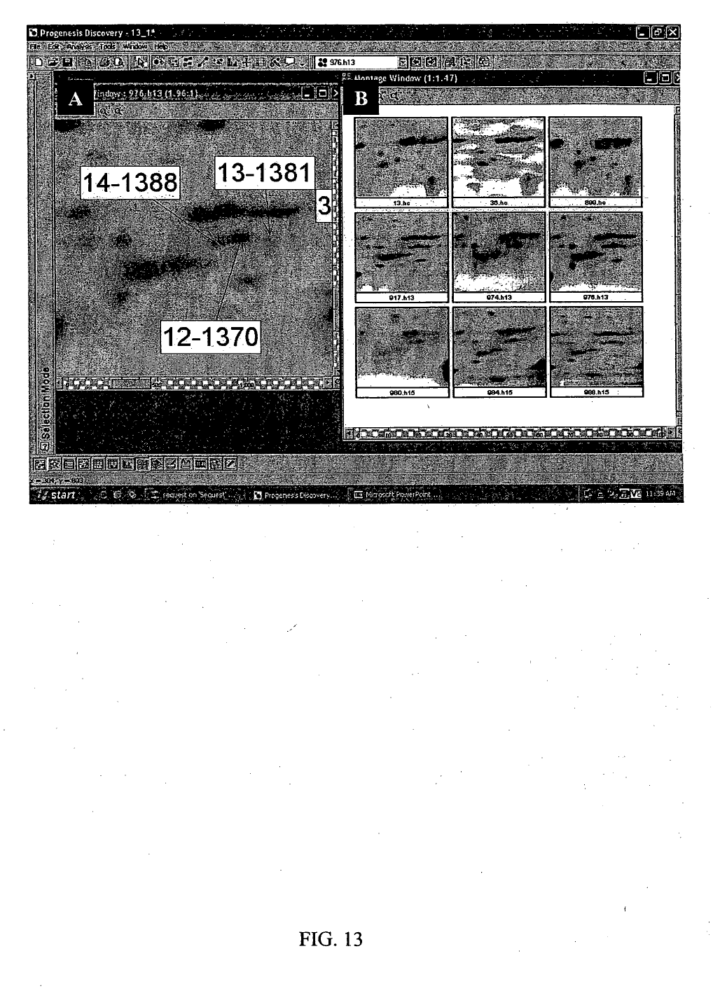

FIG. 13B shows the results of 2D gel electrophoresis of the crude extract, the Golgi fraction, and the plasma membrane fraction. Each are provided in triplicate from three individual 2D gels. FIG. 13A shows a close-up of the Golgi sample 3 and points to protein spots 12, 13, and 14. Spots 12, 13, and 14 appear to be visible in both the Golgi and plasma membrane fractions; however, the same spots do not appear evident in the crude extract sample. As such, spots 12, 13, and 14 likely represent low-abundance proteins.

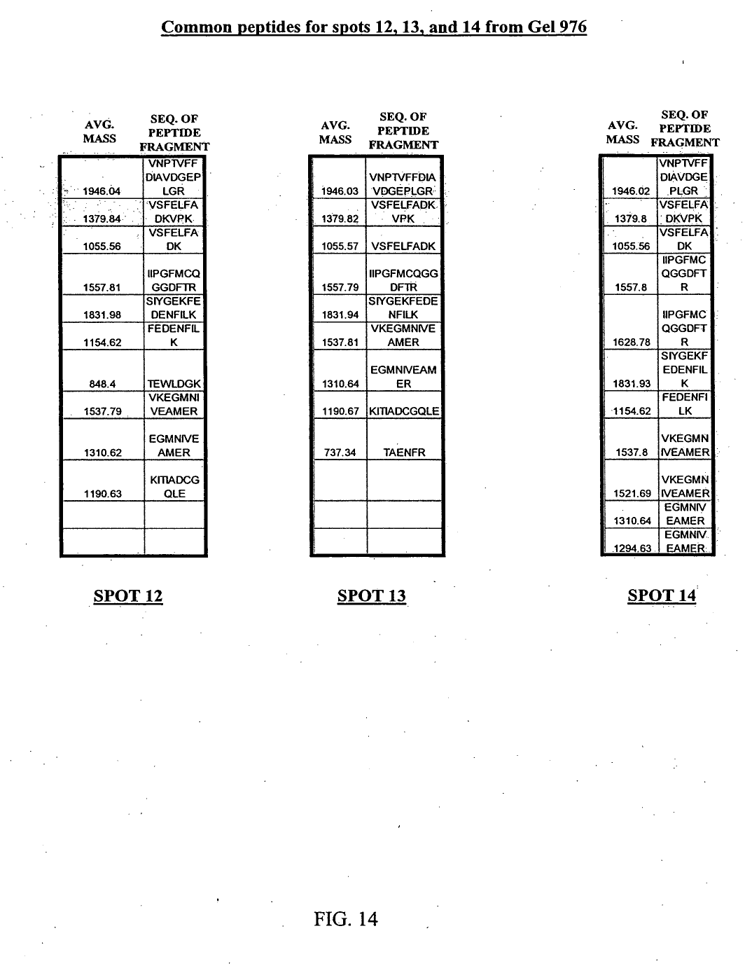

Mass spectrometry was carried out on spots 12, 13, and 14 to identify the polypeptides therein. FIG. 14 shows the mass spectrometry data for each of the peptide spots. The tables list for each spot both the sequence of the peptide fragment detected (indicated from left to right in the N-terminal to C-terminal direction) and the average molecular mass for each fragment. Upon inspection of FIG. 14, it can be noticed that the same or substantially overlapping peptide fragments are detected, which is consistent with each of the spots 12, 13, and 14 being the same protein. Thus, each of the proteins is the same or substantially same molecular mass, which is consistent with their equivalent migration distances from the top of the gel. However, since 2D gel electrophoresis resolves proteins in two dimensions, namely in one direction based on molecular mass and in another based on charge, the overall charge of the proteins must be different to the extent that they are resolved by the electrophoresis. Thus, this observation suggests that the protein spots 12, 13, and 14 are three different post-translational or other variants forms of the same protein. Perhaps, one spot represents the unmodified protein product and the remaining spots represent two unique post-translationally modified or amino acid substituted variants. Perhaps all three represent distinct variants.

The results demonstrate two advantages of the present invention. First, the results show enhanced sensitivity in the detection of low-abundance proteins, e.g., proteins that are not detectable in the crude extract but which are detected in the organelle fractions prepared by the method of the invention. Second, the results demonstrate that the fractionation method of the instant invention provides for the enhanced separation and detection of different variants of a low-abundance protein, which is an advantage given that much of the complexity of a proteome is derived from a multitude of modifications of proteins occurring during or following protein translation,—which act to alter protein characteristics, such as, for example, enzymatic activity, solubility, and stability.

### Example 6

### Analysis of Subcellular Proteomes of Various Organelle Fractions by 2D Gel Electorphoresis and Mass Spectrometry

Two-dimensional gel electrophoresis was carried out on various organelle fractions prepared according to the method of the invention. The resulting gels were appropriately stained and imaged by Progenensis™ software as described previously. Mass spectrometry was carried out as before on a plurality of protein spots. The resultant peptide fragments identified for each protein spot was compared to the sequences of proteins contained in existing databases, including GENBANK and SWISS-PROT.

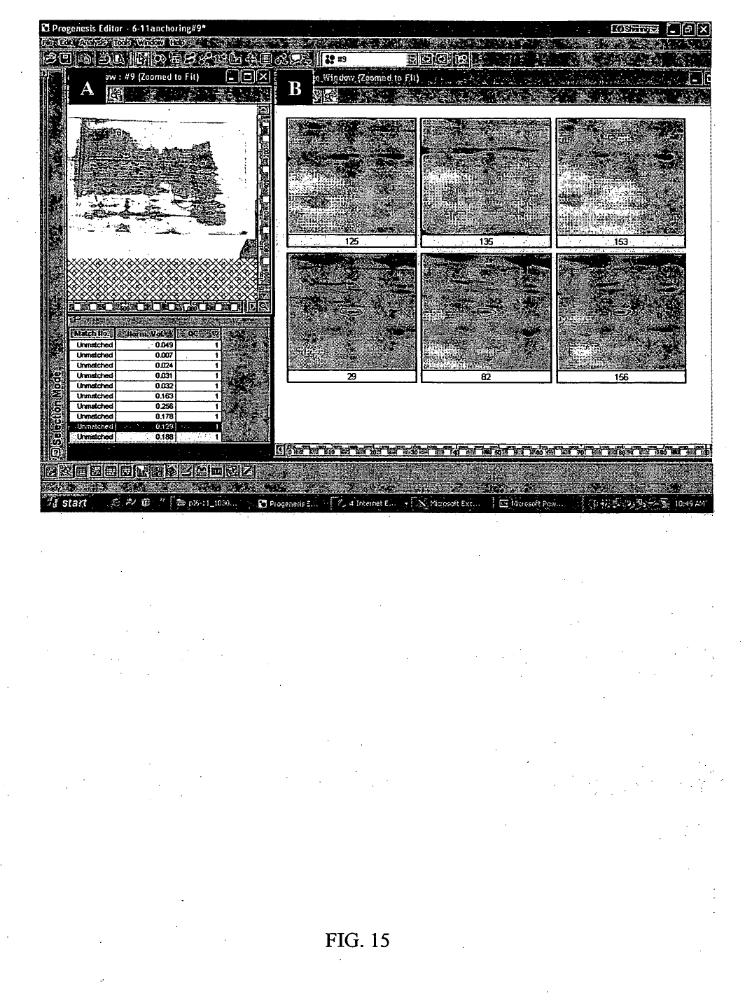

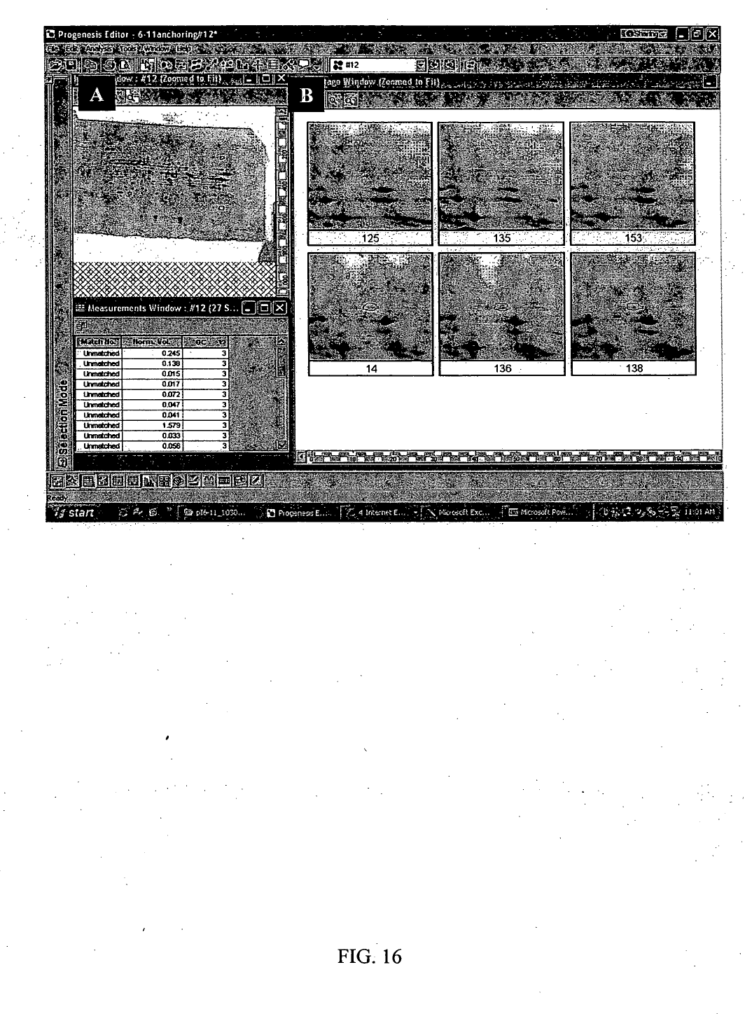

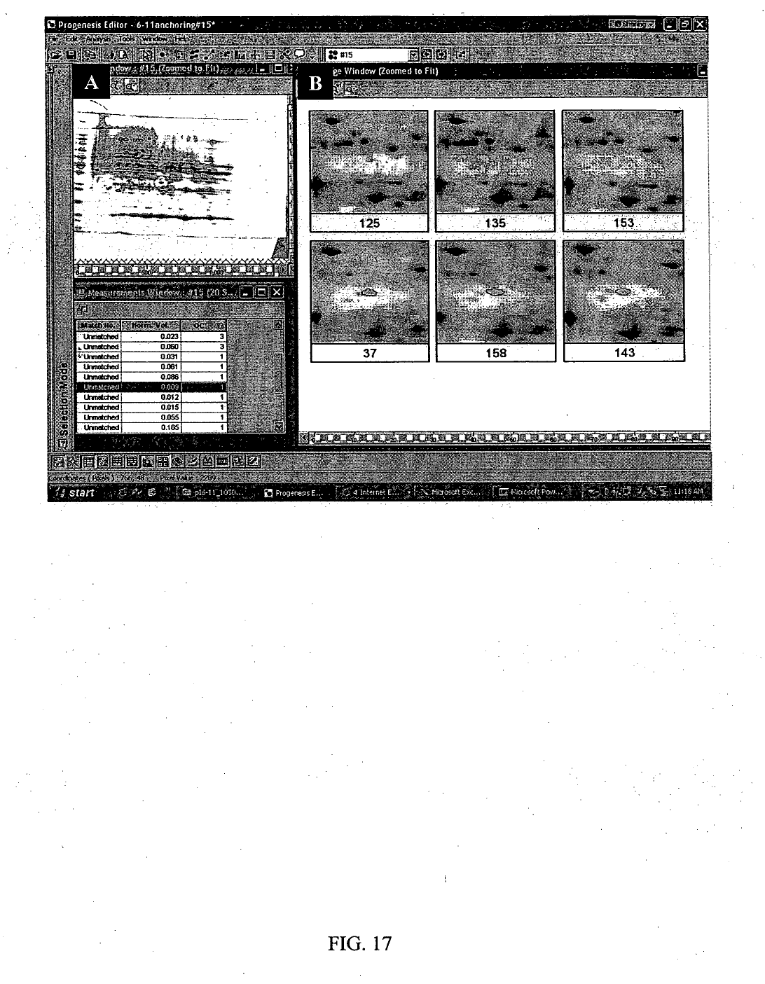

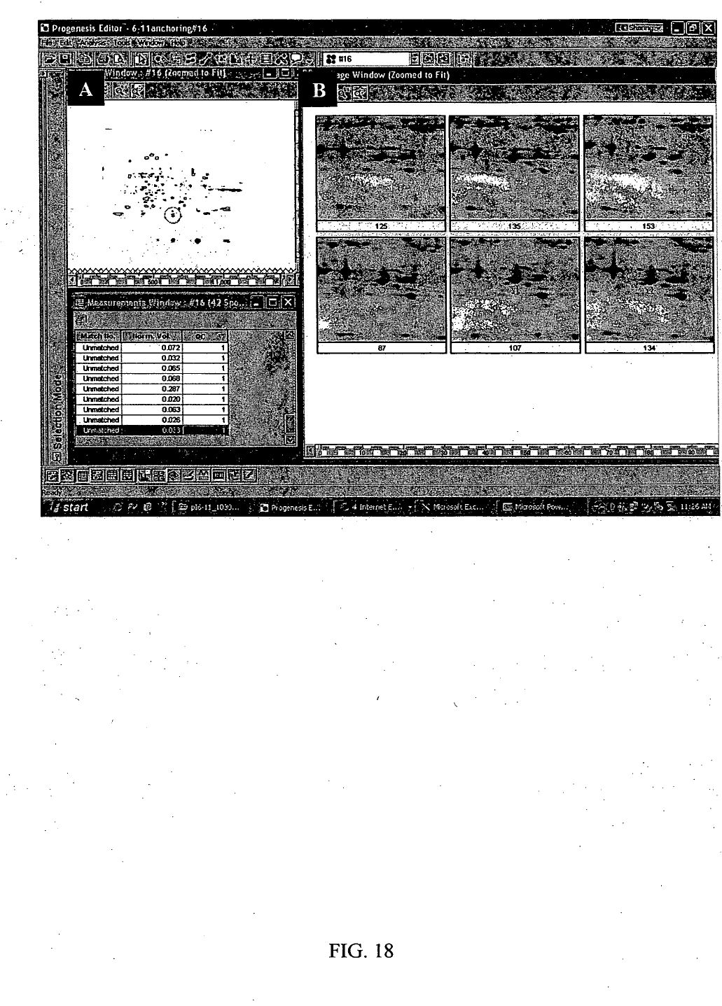

FIG. 15, FIG. 16, FIG. 17, and FIG. 18 show the results for endoplasmic reticulum, mitochondria, Golgi, and plasma membrane, respectively. In each figure, Panel A shows the complete 2D gel image of the resolved subcellular proteome for each of the organelle fractions. The complete crude extract gel is not shown. Circles indicate the location of the protein spots detected by mass spectrometry. Also for each figure, Panel B shows a localized portion of the gel in Panel A in triplicate for three individual 2D gels. The top row of Panel B shows the corresponding localized panel of the crude extract 2D gel, also shown in triplicate from three individual 2D gels.

From a comparison of the localized images of the crude extract and organelle fraction 2D gels, it can be seen that numerous protein spots are visible in the organelle fraction panels but absent from the crude extract panel. In particular, a protein spot, which is absent from the 2d gel of the respective organelle, is circled for each of the organelle fraction gel images. Thus, this suggests that the protein spots occurring in the organelle fraction gels are proteins which are not detectable in the crude extract samples. In Panel A, each of the spots of the gels of each of the FIGs was analyzed by mass spectrometry, as described previously.

This Example demonstrates that the fractionation method of the invention provides for the detection of proteins in subcellular fractions prepared by the method of the invention, said proteins not being detected in the corresponding crude extract.

### Example 7

### Parallel Isolation, Purification and Enrichment of Endoplasmic Reticulum and Plasma Membrane from Healthy and Diseased Pancreatic Tissue for Further Proteome Comparison Studies

Pancreas Homogenization. For these experiments, twenty healthy and diabetic Wistar rats (150-200 g each) are fasted overnight prior to decapitation, dissection and pancreas harvest. Pancreases (100 grams in total) are homogenized in five volumes of homogenization buffer and subjected to homogenization by mechanical shear method utilizing Waring blender.

After homogenization, the post nuclear supernatant is obtained by centrifuging the homogenate at 4-10,000×g for 10-20 minutes. The supernatant is then adjusted to isotonic conditions by addition of an equal volume of dilution buffer supplemented with protease inhibitors.

Continuous flow centrifugation. The rat pancreas homogenate is fed into the PK3-800 rotor having a pre-established sucrose gradient therein. A flow rate of approximately 10-30 ml/min is used and the PKII is operated initially at 15,000-25,000 rpm for the first pass and then at maximum speed, 40,500 rpm for the second pass. At the end of centrifuge run, the rotor contents are unloaded from the bottom of the rotor in 25 ml fractions. Samples from each fraction are analyzed to determine the capture efficiency for the target organelles, such as ER and plasma membrane.

The integrity and enrichment of the isolated organelles are determined by Western blotting, enzymatic assays and electron microscopy. For these experiments, the fractions containing plasma membrane and ER are lysed and the protein content therein is determined by Bradford assay (Bio-Rad, #500-0006). Samples are incubated with Coomassie reagent for five minutes at room temperature and the absorbance is measured at 595 nm. A standard curve is generated using BSA (Pierce, #23210).

After determining the protein concentration of the plasma membrane and ER-containing fractions, samples are mixed with 4×NuPAGE SDS sample buffer (INVITROGEN, #NP0007) and 50 mM DTT prior to being loaded into either 1.0 mm×10 well or 1.5 mm×15 well, 4-12% Bis-Tris gradient minigels (INVITROGEN#NP) 335 or NP0323) for polyacrylamide gel electrophoresis. Samples are electrophoresed for approximately 40 minutes at 150 V using MES SDS running buffer. For total protein analysis, gels are stained for 0.5 hours in Coomassie blue in 40% methanol, 10% acetic acid and subsequently distained in a 10% methanol, 10% acetic acid solution.

The fractions are measured for enrichment of organelle composition by screening each of the fractions by Western blot using anti-NaKATPase antibody for plasma membrane detection and anti-BiP/GRP78 for endoplasmic reticulum detection. Fractions are characterized using ECL detection (#RPN2108, ECL, Western Blotting Analysis System, AMERSHAM, INC) and quantified using Kodak Digital Science 1D Image Analysis software.

To assess the integrity of the isolated organelles transition electron microscopy (TEM) is employed.

To determine organelle intactness by electron microscopy, samples from the fractionation procedure are collected immediately following the centrifuge run to avoid potential damage from further manipulation. Samples are selected based on the expected density range as reported in the literature for the ER and plasma membrane. Selected fractions are pelleted and fixed in a solution of 4% formaldehyde, 1% glutaraldehyde in 0.1M phosphate buffer, pH 7.4 and stored at 4° C. until further preparation. After selection, samples are embedded, sectioned, stained with uranyl acetate and lead citrate and observed using a Zeiss electron microscope.

Additionally, to determine organelle integrity and intactness, succinate dehydrogenase enzymatic assay is performed. For these experiments, a 50 ul sample of organelle fraction is incubated with 0.3 ml of a 0.01M solution of sodium succinate (Sigma, #S2378) in 0.05M phosphate buffer, pH 7.5. Following incubation at 37° C. for 10 minutes, 0.1 ml of a 2.5 mg/ml solution of p-Iodonitrotetrazolium violet (INT) (Sigma, #18377) in 0.05M phosphate buffer, pH 7.5 is added. The tubes are incubated at 37° C. for 10 minutes. The reaction is stopped with the addition of 1.0 ml of ethyl acetate:ethanol:trichloroacetic acid in a ratio of 5:5:1 (v,v,w). The tubes were centrifuged at 15,000 RPM for 1 min before measuring the absorbance at 490 nm.

To determine whether the insulin receptor is localized to the plasma membrane or ER in the pancreatic tissue of healthy versus diabetic rats, the isolated organelles are lysed and the resulting proteins are subjected to the 2-D PAGE analysis as described in the Example 9. The gels for the healthy and diabetic rat are then compared to ascertain the location of the insulin receptor.

### Example 8

### Analysis of the Cellular Localization of Insulin Receptor Before and after Rosiglitazone Meleate Treatment of Diabetic Rats

Rosiglitazone ameleate (also known as Avandia, GSK) is a well known drug given to patients with Type II diabetes for sugar control. The molecular basis underlying the action of this drug is unknown and recent studies implicated the role of rosiglitazone in improvement of insulin secretion and changes in insulin receptor abundance and signal transduction (Diabetes, volume 52, pages 1943-1948, 2003). This example illustrates the use of the instant invention to further elucidate the molecular basis of rosiglitazone, specifically, the role of the drug to alter the cellular localization of insulin receptor.

For these experiments, adult Wistar rats are housed in groups of four animals per cage with instant access to food and water. None of the drug treatments are designed to affect general well-being of the animals. The rosiglitazone ameleate is administered to rats in drinking water. At the end of the treatment, rats are killed by decapitation. The pancreas (100 grams in total) is harvested from approximately twenty diabetic rats, those with and without drug treatment. Diabetic rats without rosiglitazone treatment are used as controls.

Pancreas Homogenization. Pancreases obtained from rats before and after rosiglitazone treatment are homogenized by mechanical shear method utilizing Waring blender. Following homogenization, the post nuclear supernatant is obtained by centrifuging the homogenate at 4-10,000×g for 10-20 minutes. The supernatant is then adjusted to isotonic conditions by addition of an equal volume of dilution buffer supplemented with protease inhibitors.

The resultant SI homogenate is reprocessed to generate a second post-nuclear supernatant using the same disruption and same centrifugation conditions as described above. The second postnuclear supernatant is equilibrated to isotonic conditions and used as a feed material for the PKII (Alfa Wasserman) centrifuge.

Continuous-flow centrifugation. For these experiments, the sucrose gradient is established in the PK3-800 rotor after which the rat pancreas homogenate is fed into the centrifuge. A flow rate of approximately 10-30 ml/min is used and the PKII is operated initially at 15,000-25,000 rpm for the first pass and then at maximum speed, 40,500 rpm for the second pass. Samples from the effluent are captured and further analyzed to determine the capture efficiency for ER and plasma membrane. These organelles are given additional time to reach their densities after all the homogenate had been fed to the system. The rotor is brought to a controlled stop and the contents are unloaded from the bottom in 25 ml aliquots.

After centrifugation, the intactness and enrichment of isolated ER and plasma membrane are determined by Western blotting, enzymatic assays and electron microscopy as described in Example 7.

To determine the differences in cellular localization of insulin receptor before and after rosiglitazone treatment, the isolated organelles are lysed and further subjected to 2-D PAGE as described in Example 9.

### Example 9

### Analysis of Plasma Membrane and ER Proteomes by 2D Gel Electrophoresis

The subcellular proteomes of the ER and plasma membrane of the fractions provided by Examples 7 and 8 are further analyzed by 2D gel electrophoresis. To analyze the subcellular proteomes, proteins are separated by two-dimensional gel electrophoresis. Separation of ER and plasma membrane extracts, subsequent to organelle lysis, is performed by 2D-PAGE and detection is by either Coomassie blue, silver staining or Sypro Ruby (Molecular Probes). Digital images of the 2D gels are generated and annotated using Z3 software (Compugen) or Progenesis software (Nonlinear). Resultant images are superimposed to identify spots corresponding to insulin receptor.

Thus, the protein spot patterns of ER and plasma membrane are analyzed and the insulin receptor localization in diabetic pancreatic tissue before and after rosiglitazone treatment is compared to the insulin receptor localization in healthy pancreatic tissue.

This example illustrates how combining subcellular fractions obtained by the PKII system with 2D gel electrophoresis allows one skilled in the art to achieve one of the major goals of subcellular proteomics, namely, monitoring protein translocation events.

### Example 10

### Estimatation of Theoretical Amounts of Biological Material Necessary to Detect a Protein Relative to its Copy Number in a Cell

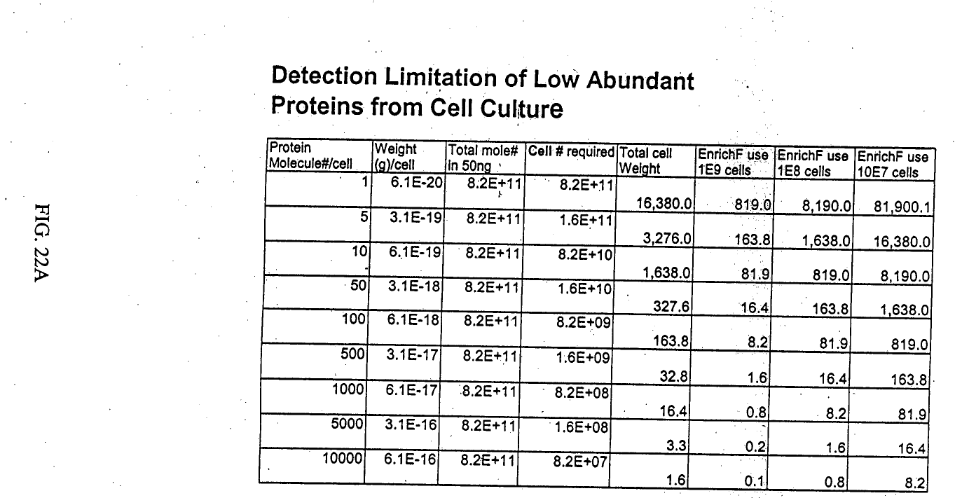

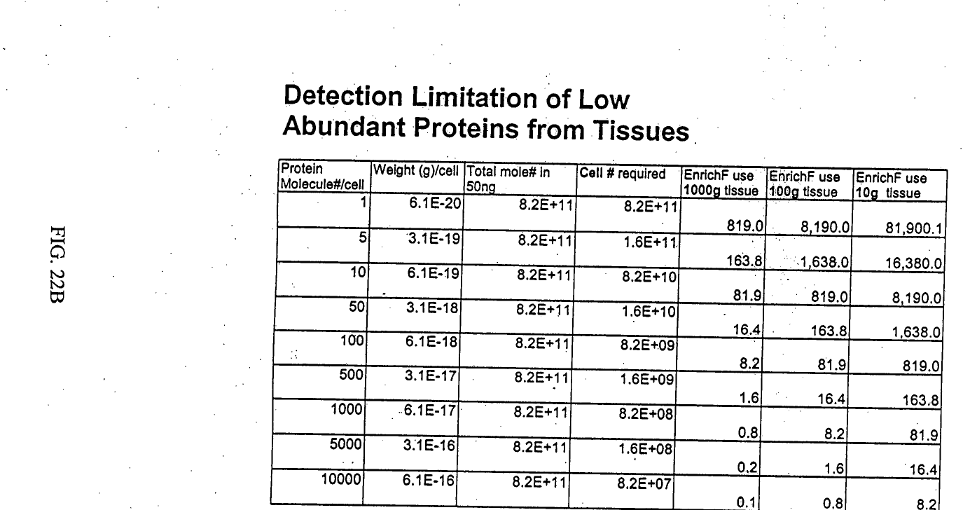

FIGS. 22A and 22B illustrate the advantages of using the continuous-flow process of the invention. For example, the figures indicate the folds of accumulation required for a particular amount of starting biological material typically needed to reach the detection limit of 50 ng in relation to the copy number of a protein in a cell. In one embodiment, referring to FIG. 22A given 1×10(9) cells of starting biological material, one would need to use an 819-fold increase in cell number to reach the detection limit of 50 ng for a protein occurring at a single copy per cell.

Those skilled in the art will recognize, or be able to ascertain without undue experimentation any of the numerous equivalents to the embodiments of the invention described herein. All such equivalents are considered to be within the scope of the instant invention and are encompassed by the claims that follow.

Unless otherwise explained, all technical and scientific terms used herein have the same meaning as commonly understood by one of ordinary skill in the art to which the invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including explanations of terms, will control. In addition, the materials, methods, and examples are illustrative only and not intended to be limiting.

Although preferred embodiments of the present invention and modifications thereof have been described in detail herein, it is to be understood that this invention is not limited to those precise embodiments and modifications, and that other modifications and variations may be affected by one skilled in the art without departing from the spirit and scope of the invention as defined by the appended claims.

We claim:

1. A method for collecting organelles from a sample comprising the organelles, comprising the steps of:
a) releasing the organelles from the sample;
b) introducing the organelles into a density gradient within a continuous-flow centrifuge;
c) applying a centrifugal force sufficient for at least two types of organelles to migrate within the density gradient; and
d) collecting the at least two types of organelles from the density gradient.

2. The method according to claim 1, wherein said organelles comprise sub-types of organelles.

3. The method according to claim 1, wherein said sample is a biological sample.

4. The method according to claim 3, wherein said biological sample comprises an organ, bodily fluid, blood, serum, plasma, saliva, tears, feces, urine, semen, mucous, tissue, tissue homogenate, cellular extract, or spinal fluid or combinations thereof.

5. The method according to claim 1, wherein said continuous-flow centrifuge is a continuous-flow ultracentrifuge.

6. The method according to claim 1, wherein said continuous-flow centrifuge comprises a zonal rotor.

7. The method according to claim 1, further including the step of utilizing the collected at least two types of organelles by selling the organelles, leasing the organelles, licensing the organelles, protecting the intellectual property interest in the organelles, placing information the organelles into a database or viewing information about the organelles that was placed in a database.

8. The method according to claim 1, wherein the density gradient is selected from the group consisting of cesium chloride, cesium sulfate, nonelectrolyte solutes, polysaccharides, iodinated nonelectrolytes and colloidal silica coated with polyvinylpyrrolidone.

9. The method according to claim 1, wherein the releasing step comprises homogenization and/or lysing.

10. The method according to claim 1, wherein each of the at least two types of organelles has a buoyant density and wherein said centrifugal force is sufficient to cause each of the at least two types of organelles to migrate to a density in the gradient density that is substantially equal to each respective buoyant density.

11. The method according to claim 1, wherein said at least two types of organelles migrate within said density gradient in a single run.

12. The method according to claim 1, wherein the at least two types of organelles collected are at least about 60 percent intact.

13. The method according to claim 1 or claim 10, further comprising the steps of lysing the at least two types of organelles to form a proteome containing a protein; and collecting a protein from the proteome.

14. The method according to claim 13, wherein the protein collected is a low-abundance protein.

15. The method according to claim 14, wherein the protein collected is present in a cell in an amount of less than about 100 copies per cell.

16. The method according to claim 15, wherein the protein collected is present in a cell in an amount of about 1 copy per cell.

17. The method according to claim 1 or 10, wherein said at least two types of organelles are enriched and accumulated in the density gradient.

18. The method according to claim 5, wherein the continuous-flow ultracentrifuge comprises a rotor having a volume capacity of from about 100 ml to about 8 liters.

19. A method for obtaining a low-abundance protein from a population of organelles, comprising the steps of introducing the population of organelles into a density gradient within a continuous-flow centrifuge while applying a centrifugal force in an amount sufficient for an organelle type to enrich and accumulate within a section of the density gradient in a quantity sufficient to contain a detectable amount of the low-abundance protein when the quantity of the organelle type is collected.

20. The method according to claim 19, including the further step of releasing a population of organelles from a biological sample of homogenizing and/or lysing the biological sample before introducing the population of organelles into the density gradient.

21. The method according to claim 19, including the further step of collecting the low-abundance protein.

22. The method according to claim 21, wherein collection of the low-abundance protein includes lysing the organelle.

23. The method according to claim 22, wherein the low-abundance protein is isolated in a substantially pure form.

24. The method according to claim 19 or 21, wherein the population of organelles is introduced continuously or intermittently while continuously applying a centrifugal force to the density gradient.

25. The method according to claim 24, including the further step of utilizing the low-abundance protein by selling the low-abundance protein, leasing the low-abundance protein, licensing the low-abundance protein, protecting the intellectual property interest in the low-abundance protein, placing information about the low-abundance protein into a database or viewing information about the low-abundance protein in a database.

26. A method for separating at least two types of organelles from a biological sample, comprising the steps of:
a) homogenizing biological sample and/or lysing cell material to form an homogenate;
b) continuously or intermittently feeding and recycling the homogenate into a rotating continuous-flow ultracentrifuge containing a density gradient;
c) applying a centrifugal force during and after the feeding step to the density gradient in the ultracentrifuge such that each of the at least two types of subcellular organelles enrich and accumulate at a position within the density gradient; and
d) collecting each of the at least two types of subcellular organelles from its respective position in the density gradient.

27. A method for obtaining an organelle type, comprising the step of passing a biological sample containing a plurality of organelle types through a rotating continuous-flow ultracentrifuge to enrich and accumulate a single organelle type from a biological sample in a sufficient amount to isolate and detect a low-abundance protein from the single organelle type.

28. The method according to claim 27, wherein the low-abundance protein is present in a cell in less than about 100 copies per cell.

29. The method according to claim 28, wherein the low-abundance protein is present in a cell in less than about 10 copies per cell.

30. The method according to claim 28, wherein the low-abundance protein is present in a cell in about 1 copy per cell.

31. The method for analyzing the proteomic profiles of at least two different types of organelles, comprising the steps of:
a) obtaining a first biological sample containing at least first and second types of organelles, the first and second organelle types being different types of organelles, the first organelle type containing a first organelle and the second organelle type containing a second organelle, each of the first and second organelles having a buoyant density;
b) releasing the first and second organelles from the first biological sample;
c) introducing the first and second organelles into a density gradient within a continuous-flow centrifuge while applying a centrifugal force sufficient for the first organelle to migrate within the density gradient to a first position at which the density of the density gradient is substantially equal to the buoyant density of the first organelle and which is sufficient for the second organelle to migrate within the density gradient to a second position, which may be the same or different than the first position, at which the density of the density gradient is substantially equal to the buoyant density of the second organelle;
d) collecting the first organelle and the second organelle;
e) isolating a first protein from the first organelle and a second protein from the second organelle; and
f) analyzing the proteomic profile of the first protein and the second protein.

32. The method according to claim 31, including the further steps of:
a) obtaining a second biological sample containing at least third and fourth types of organelles, the third and fourth organelle types being different types of organelles, the third organelle type containing a third organelle and the fourth organelle type containing a fourth organelle, each of the third and fourth organelles having a buoyant density;
b) repeating steps b), c) and d) of claim 31 using the third organelle and fourth organelles in place of the first and second organelles;
c) isolating a third protein from the third organelle and a fourth protein from the fourth organelle; and
d) analyzing the proteomic profile of the third organelle and the fourth organelle.

33. The method according to claim 32, wherein the first organelle type is the same as the third organelle type and the second organelle type is the same as the fourth organelle type.

34. The method according to claim 33, wherein the proteomic profiles of the first organelle is compared to the third organelle and the proteomic profile of the second organelle is compared to the fourth organelle.

35. The method according to claim 34, wherein the first biological sample is obtained from a source at a first time and the second biological sample is obtained from the same source at a second time.

36. The method according to claim 34, wherein the same source is one or more living hosts.

37. The method according to claim 36, wherein the same source is one living host.

38. A method for analyzing the translocation of a protein in a biological sample containing first and second organelles at a first time and at a second time, comprising the steps of:
a) obtaining a protein in the first organelle of a biological sample, the biological sample being obtained at a first time, by:
i) homogenizing the first biological sample under conditions sufficient to release a first organelle having a density into a homogenate, the first organelle including a first protein;
ii) introducing the homogenate into a density gradient of a rotating continuous flow ultracentrifuge;
iii) applying a centrifugal force from the ultracentrifuge to the homogenate such that the first organelle migrates within the density gradient to a position in the density gradient that is substantially equal to the density of the first organelle;
iv) removing the first organelle from the density gradient;
v) detecting and characterizing the first protein in the first organelle of the first biological sample;
b) obtaining a second protein, which is the same type of protein as the first type, in a second organelle from a biological sample, the biological sample being obtained at a second time, comprising carrying out the steps of (a)(i) through (a)(v) above using the biological sample obtained at the second time; and
c) comparing the location of the first and second proteins.

39. The method according to claim 38, wherein the first organelle comprises a plurality of first organelles and the second organelle comprises a plurality of second organelles and the first protein comprises a plurality of first proteins and the second protein comprises a plurality of second proteins.
